(19) United States
(12) Patent Application Publication
(10) Pub. No.: US 2025/0289736 A1
(43) Pub. Date: Sep. 18, 2025

(54) METHOD AND SYSTEM FOR CLEANING A DENTAL WATER SUPPLY

(71) Applicant: PROEDGE DENTAL PRODUCTS, INC., Centennial, CO (US)

(72) Inventors: Gregg A. WICKEN, Broomfield, CO (US); Mark A. FRAMPTON, Centennial, CO (US)

(21) Appl. No.: 19/079,231

(22) Filed: Mar. 13, 2025

Related U.S. Application Data
(60) Provisional application No. 63/564,896, filed on Mar. 13, 2024.

(51) Int. Cl. C02F 1/44; B01D 63/02; C02F 1/50; C02F 103/02

(52) U.S. Cl. CPC C02F 1/44; B01D 63/02; C02F 1/50; B01D 2313/08; B01D 2313/12; B01D 2313/13; B01D 2313/201; B01D 2313/21; C02F 2103/026; C02F 2201/004; C02F 2303/04; C02F 2307/14

(57) ABSTRACT

A system for removing a microbe from a liquid comprising: a housing; a microbial filter disposed within the housing; a disinfecting agent disposed in the housing. A flow of the liquid passes through the microbial filter and the disinfecting agent thereby trapping and/or killing the microbe, generating a cleaned liquid.

### CROSS-REFERENCE TO RELATED APPLICATIONS

This application claims the benefit of priority pursuant to 35 U.S.C. 119 (e) of U.S. Provisional Patent Application 63/564,896, filed Mar. 13, 2024, entitled “Method and System for Cleaning a Dental Water Supply,” which is hereby incorporated by reference herein in its entirety.

### BACKGROUND

Microorganisms such as non-tuberculosis mycobacteria (NTMs) pose a significant challenge in dental settings, as they are resistant to traditional methods of killing and removal. This is at least partly due to their waxy coating and their ability to form biofilms on various surfaces, making them resilient to common disinfection techniques. Additionally, NTMs can persist in water systems and dental unit water lines, leading to recurring contamination, despite regular cleaning and maintenance efforts. Consequently, traditional methods such as low level anti-microbials (e.g., chlorine in city water) may not effectively eradicate NTMs, contributing to the ongoing risk of infection and transmission within dental environments.

An NTM infection in a dental patient can lead to various consequences, including prolonged and potentially severe health implications. NTMs can cause a range of infections, such as pulmonary, skin and soft tissue, and disseminated infections, posing a significant risk to immunocompromised individuals or those with underlying respiratory conditions. In the dental setting, NTM infections can result in oral manifestations, such as oral ulcers, abscesses, and lymphadenitis, compromising the patient's oral health and overall well-being. Furthermore, the challenges in diagnosing NTM infections, coupled with their resistance to traditional antibiotics, can lead to delayed or ineffective treatment, potentially exacerbating the infection and increasing the likelihood of complications. As such, NTM infections in dental patients can have far-reaching consequences, necessitating improved techniques to kill, trap and/or remove NTMs before they can cause infection.

### SUMMARY

Systems and apparatuses for killing and/or removing a microbe from a water supply are disclosed herein. In one aspect, a system for removing a microbe from a water supply includes a housing, a microbial filter disposed within the housing, a disinfecting agent disposed in the housing, where a flow of a liquid passes through the microbial filter and the disinfecting agent thereby trapping the microbes. The system may also include where the microbe includes a non-tuberculosis mycobacterium. The water supply of the system may include a dental water supply. The disinfecting agent may include at least one of: iodine, silver, copper, titanium, chlorine dioxide, chlorhexidine gluconate, hydrogen peroxide, cetylpyridinium chloride, or combinations thereof. The system may further include an enclosure configured to receive the housing. The microbial filter of the system may include a hollow fiber filter. The liquid of the system may flow through the microbial filter and subsequently encounter the disinfecting agent. The liquid of the system may also encounter the disinfecting agent and subsequently flow through the microbial filter. The system may also include where the liquid flows into a lumen in the hollow fiber and subsequently through a wall of the hollow fiber. The system may also include where the liquid flows through a wall of the hollow fiber and subsequently into a lumen of the hollow fiber. Other technical features may be readily apparent to one skilled in the art from the following figures, descriptions, and claims.

Optionally, in some embodiment, the microbe may include a non-tuberculosis mycobacterium.

Optionally, in some embodiment, the water supply includes one or more of a dental water supply or source water.

Optionally, in some embodiment, the disinfecting agent comprises at least one of: iodine, silver, copper, titanium, chlorine dioxide, chlorhexidine gluconate, hydrogen peroxide, cetylpyridinium chloride, or combinations thereof.

Optionally, in some embodiment, the system includes an enclosure configured to receive the housing.

Optionally, in some embodiments, the system includes a coupling portion coupled to a neck portion of the housing, a conduit extending at least partially within the coupling portion and defining a terminal end, and adaptor coupled to the terminal end of the conduit, wherein the adaptor couples to an aperture defined by the coupling portion, and an interior of the conduit is in fluid communication with the housing through a flow path defined by the coupling portion and the adaptor.

Optionally, in some embodiment, the enclosure includes a release mechanism to provide access to the housing.

Optionally, in some embodiments, the system includes a collar, the collar including: a lumen formed therein and configured to receive a hook-shaped adaptor, the hook-shaped adaptor fluidly coupled to a conduit, and a flow path formed within the collar, wherein: a first end of the flow path is couplable to a neck portion of the housing and receives the cleaned liquid, the cleaned fluid passes from the first end of the flow path, through the flow path to a second end of the flow path, the hook-shaped adaptor is received in, and fluidly coupled to, the second end of the flow path, and the conduit receives the cleaned fluid via the hook-shaped adaptor.

Optionally, in some embodiment, the microbial filter comprises a hollow fiber filter.

Optionally, in some embodiment, the liquid flows into a lumen in the hollow fiber and subsequently through a wall of the hollow fiber.

Optionally, in some embodiments, the liquid flows through a wall of the hollow fiber and subsequently into a lumen of the hollow fiber.

Optionally, in some embodiments, the liquid encounters the microbial filter and subsequently encounters the disinfecting agent.

Optionally, in some embodiments, the liquid encounters the disinfecting agent and subsequently encounters the microbial filter.

Optionally, in some embodiments, the disinfecting agent provides a residual action downstream of the system.

Optionally, in some embodiments, the housing includes a neck portion defining a first plurality of apertures, an upper portion defining a first plurality of tangs and a second plurality of apertures, a lower portion defining a second plurality of tangs and a third plurality of apertures, an end cap defining a third plurality of tangs, wherein the first plurality of tangs, the second plurality of tangs, and the third plurality of tangs are receivable in the first plurality of apertures, the second plurality of apertures, and the third plurality of apertures respectively to couple the neck portion to the upper portion, the upper portion to the lower portion, and the lower portion to the end cap respectively.

Also disclosed is a method to treat a fluid for dental use, including receiving the fluid in a housing, filtering the fluid with a filter disposed in the housing, and disinfecting the fluid with a disinfectant disposed in the housing.

Optionally, in some embodiments, the method includes the filter includes a hollow fiber filter.

Optionally, in some embodiments, the method includes a pore size of the hollow fiber filter is less than or equal to 0.2 microns.

Optionally, in some embodiments, the method includes the disinfectant is at least one of: iodine, silver, copper, titanium, chlorine dioxide, chlorhexidine gluconate, hydrogen peroxide, cetylpyridinium chloride, or combinations thereof.

Optionally, in some embodiments, the method includes the fluid is disinfected subsequent to filtering.

Optionally, in some embodiments, the method includes the fluid is filtered subsequent to disinfecting.

Optionally, in some embodiments, the method includes accumulating the fluid in a vessel subsequent to filtering and disinfecting.

### BRIEF DESCRIPTION OF THE DRAWINGS

FIG. 1 is an isometric view of an example of a system for cleaning a dental water supply.

FIG. 2 is a section view of the system of FIG. 1, taken along line 2-2 of FIG. 1

FIG. 3 is an isometric view of an enclosure for use with the system of FIG. 1.

FIG. 4 is a section view of the enclosure of FIG. 3 and the system of FIG. 1, taken along line 4-4 of FIG. 3.

FIG. 5 is a partially exploded section view of the system of FIG. 1 taken along line 2-2 of FIG. 1.

FIG. 6 is a section view of an embodiment of an upper body and microbial filter of the system of FIG. 1 taken along line 2-2 of FIG. 1.

FIG. 7 is an isometric view of an embodiment of a microbial filter.

FIG. 8 is a section view of the embodiment of the microbial filter of FIG. 7 housed within an upper body, taken along line 2-2 of FIG. 1.

FIG. 9 is a partially exploded elevation view of the system of FIG. 1.

FIG. 10 is a schematic view of an embodiment of a system for cleaning a dental water supply.

FIG. 11 is a flow chart of an embodiment of a method of using the systems for cleaning a dental water supply disclosed herein.

FIG. 12A is a cross section of an embodiment of a microbial filter suitable for use with the systems for cleaning a dental water supply disclosed herein.

FIG. 12B is a cross section of an embodiment of a microbial filter suitable for use with the systems for cleaning a dental water supply disclosed herein.

FIG. 13A show a partially exploded view of an embodiment of a system used to clean a dental water supply disclosed herein.

FIG. 13B is an isometric view of the system shown FIG. 13A.

FIG. 14 is an isometric view of an enclosure and dental water supply for use with the system of FIG. 13A and FIG. 13B.

FIG. 15 is a partially exploded view of the enclosure of FIG. 14.

FIG. 16 is a section view of the enclosure of FIG. 14, showing the system of FIGS. 13A and 13B taken along line 16-16 of FIG. 15.

FIG. 17 is a partially exploded elevation view of an upper portion of the system of FIGS. 13A and 13B.

FIG. 18 is a partially exploded elevation view of a lower portion of the system of FIGS. 13A and 13B.

FIG. 19 is a partially exploded view of a collar of the enclosure and housing of the dental water supply of FIG. 14.

FIG. 20A is a partial section view of the collar of the enclosure of FIG. 14 taken along line 20-20 of FIG. 19.

FIG. 20B is a section view of the collar and lid portion of the enclosure of FIG. 14 taken along line 16-16 of FIG. 15.

FIG. 21 is an isometric view of the system of FIG. 1.

FIG. 22 is a partially transparent view of the system of FIG. 1.

FIG. 23 is a section view of the system of FIG. 1 taken along the line 2-2 of FIG. 1.

FIG. 24 is a partially transparent section view of the system of FIG. 1, taken along line 2-2 of FIG. 1.

FIG. 25 is a partially exploded isometric of the system of FIG. 1.

FIG. 26 is an isometric view of an enclosure for use with the system of FIG. 1.

FIG. 27 is a section view of FIG. 26 taken along line 4-4 of FIG. 3.

FIG. 28 is an isometric view of an example of an upper portion of the system of FIG. 1.

FIG. 29 is a partially transparent isometric view of an example of an upper portion of the system of FIG. 1.

.

FIG. 30 is an isometric section view of the upper portion of FIG. 29 taken along line 2-2 of FIG. 1.

FIG. 31 is a section view of the upper portion of FIG. 29 taken along line 2-2 of FIG. 1.

### DETAILED DESCRIPTION

Novel systems and methods to clean a fluid, particularly a dental water line, are disclosed. The disclosed systems can effectively remove microbes (either pathogenic or non-pathogenic) such as NTMs. It may be important to remove non-pathogenic microbes, as these can create conditions such as biofilms that can harbor pathogenic organisms. The systems include a microbial filter and a disinfecting agent. In some embodiments, the microbial filter is a hollow fiber filter.

In some embodiments, the microbial filter can remove microorganisms such as: bacteria, protozoa, viruses, NTMs, protists, and the like. Bacteria may range in size from about 0.2 micrometers (microns) to about 2 microns. Microbial filters with a pore size of 0.2 micrometers or smaller are effective in removing bacteria from fluids or air. Protozoa are larger microorganisms, with sizes ranging from 2 to 50 micrometers. Filters with a pore size of 1 micrometer or smaller can effectively remove protozoa from water sources. Virus sizes typically range from 0.02 to 0.3 micrometers. Filters with a pore size of 0.01 micrometers or smaller are required to effectively remove viruses from water or air. Non-tuberculosis mycobacteria (NTMs) are larger microorganisms compared to many bacteria and viruses, with sizes typically ranging from 0.5 to 4 micrometers. To effectively remove NTMs from liquids or air, filters with a pore size of 0.2 micrometers or smaller can be used. Protists, which include various eukaryotic microorganisms such as algae and protozoa, can have a wide range of sizes. Algae can vary significantly in size, spanning from several micrometers to much larger sizes depending on the species. For effective removal of algae and larger protists, filters with a pore size of 1 micrometer or smaller can be used, depending on the specific requirements of the water or air filtration system. It is important to consider the diversity of protist sizes and adapt filtration strategies accordingly to achieve efficient removal.

The microbial filters disclosed herein can effectively trap at least some or all of the microorganisms and viruses described herein. In some embodiments, the microbial filter 202 is a hollow fiber filter.

The disinfecting agents used in the system 100 may include those safe for use in a dental patient's mouth (e.g., may be swished in the mouth or gargled but not usually swallowed). Disinfecting agents may include, but are not limited to, iodine, silver, copper, titanium, chlorine dioxide, chlorhexidine gluconate, hydrogen peroxide, cetylpyridinium chloride, or combinations thereof. In some embodiments, other types of disinfection are contemplated, including the use of ultraviolet light and/or ozonation. In many embodiments, the disinfecting agent may include ion exchange resin beads, granules, or the like that release the disinfecting agent into the liquid to be cleaned by the system. In many embodiments, the disinfecting agent provides a residual downstream effect in tubing, plumbing, systems, etc. downstream of the system. For example, a portion of the disinfecting agent may pass through the microbial filter with the cleaned fluid and continue to provide a cleaning or disinfecting action downstream of the system. Thus, the system 100 can clean water from a source (e.g., a city water hookup) to a point of use (e.g., a dental handpiece, an air/water syringe, etc.).

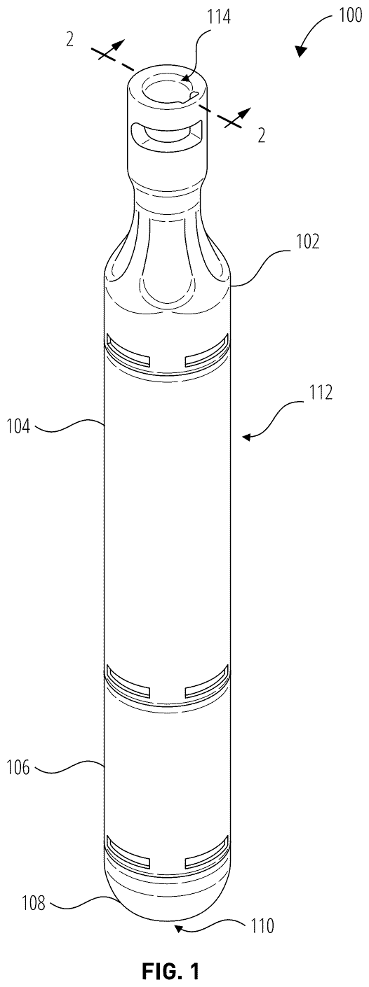

Turning to the figures, FIG. 1 shows an example of the system 100. The system 100 may include a housing 112, which includes a neck portion 102, an upper portion 104, a lower portion 106, an end cap 108, and an inlet 110. The components of the housing 112 may be coupled by various means. For example, the components may define threading and may couple together by rotation while inserting one component into another. In other examples, components may define apertures where fasteners couple the components together components. Fasteners may include screws, bolts, nuts, rivets, pins, combinations thereof, etc. In some embodiments, the components of the housing 112 may be coupled together using a combination of threading and fasteners. In some embodiments, the components of the housing 112 may be coupled together using apertures and protrusions, or tangs. In these embodiments, the housing 112 components may join together by fitting the component end with tangs into another component with apertures in a click-to-lock system. In some embodiments, a combination of click-to-lock, threading, and/or fasteners may be used to couple the components of the housing 112. Various materials may make up the housing 112. For example, the housing 112 may be made of a plastic material, a metal, or combinations thereof. In some embodiments, the housing 112 material may be selected to work with a particular disinfecting agent 214. For example, the material may be selected so that the disinfecting agent 214 does not corrode the housing 112. In other examples, the material may be selected to increase the efficacy of killing microorganisms and/or viruses.

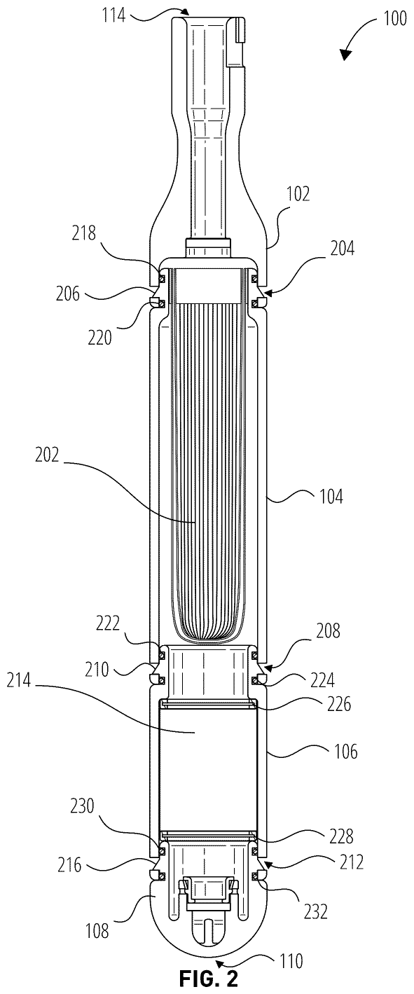

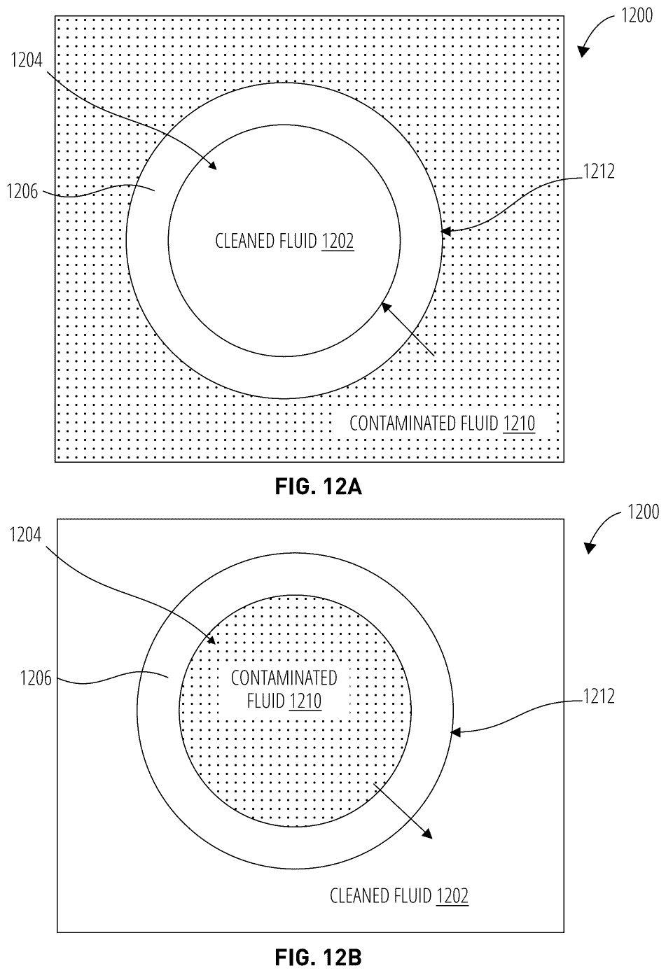

FIG. 2 is a section view of the example system of FIG. 1 taken along cross-sectional line 2-2 of FIG. 1. As shown for example in FIG. 2, a microbial filter 202 may be disposed in the housing 112, such as in the upper portion 104. The neck portion 102 may define a plurality of apertures 204. The upper portion 104 may define a plurality of tangs 206. The neck portion 102 and the upper portion 104 may couple together by fitting the plurality of tangs 206 in the plurality of apertures 204. A seal 218 and a seal 220 may prevent fluid 1210 (as shown for example in FIGS. 12A and 12B) from flowing outside of the system 100 where the neck portion 102 and the upper portion 104 couple together. In some embodiments, the seal 218 and the seal 220 may include an o-ring, a gasket, a polymer sealant, a polymer tape, or a combination thereof. The neck portion 102 may define an aperture 114.

As shown for example in FIG. 2, the upper portion 104 may couple with the lower portion 106 by fitting a plurality of tangs 210 defined by the lower portion 106 into a plurality of apertures 208 defined by the upper portion 104. In some embodiments, the upper portion 104 may couple together with the second upper portion 104. By coupling at least two of the upper portions 104 together, the system 100 may include two or more of the microbial filters 202. A seal 222 and a seal 224 may prevent fluid 1210 from flowing outside of the system 100 where the upper portion 104 and the lower portion 106 couple together. In some embodiments, the seal 222 and the seal 224 may include an o-ring, a gasket, a polymer sealant, a polymer tape, or a combination thereof.

As shown for example in FIG. 2, the disinfecting agent 214 may be disposed in the lower portion 106. A seal 226 and a seal 228 may prevent fluid 1210 from flowing outside of the system 100. In some embodiments, the microbial filter 202 may be disposed in the lower portion 106 and the disinfecting agent 214 in the upper portion 104. In some embodiments, the microbial filter 202 and the disinfecting agent 214 may be combined. In some embodiments, fluid 1210 may flow through the microbial filter 202 and may subsequently come into contact with the disinfecting agent 214. In some embodiments, fluid 1210 may come into contact with the disinfecting agent 214 and may subsequently flow through the microbial filter 202. In some embodiments, a plurality of microbial filters 202 may be used. For example, multiple microbial filters 202 may be disposed in series or in parallel, which may increase a volumetric flow rate of filtered fluid 1202 compared to the volumetric flow rate of a single microbial filter 202. Additionally, using multiple of the microbial filters 202 in the system 100 may increase the lifetime of the microbial filter 202 compared to when the system 100 uses a single of the microbial filter 202. Using multiple of the microbial filters 202 may also decrease a pressure drop determined by an inside fluid pressure of the microbial filter 202 and an outside fluid pressure of the microbial filter 202, compared to when the system 100 uses a single of the microbial filter 202.

As shown for example in FIG. 2, the lower portion 106 may couple with the end cap 108 by fitting a plurality of tangs 216 defined by the end cap 108 into a plurality of apertures 212 defined by the lower portion 106. In some embodiments, the lower portion 106 may couple together with at least another of the lower portion 106. By coupling at least two of the lower portions 106 together, the system 100 may include at least two of the disinfecting agent 214. A seal 230 and a seal 232 may prevent fluid 1210 from flowing outside of the system 100 where the lower portion 106 and the end cap 108 couple together. In some embodiments, the seal 230 and the seal 232 may include an o-ring, a gasket, a polymer sealant, a polymer tape, or a combination thereof.

In some embodiments, the microbial filter 202 may be a hollow fiber filter. For example, a plurality of semi-permeable hollow fibers may be included in the microbial filter 202. As fluid 1210 flows within the hollow fibers, the fluid 1210 will also pass through pores of the fibers to the outside of the fiber. The fluid 1210 retained within the fiber will also retain microorganisms, including NTMs, and suspended solids. Various pore sizes are contemplated, including pore sizes ranging from 0.01 microns to 2.0 microns. In other embodiments, fluid 1210 may flow outside the fibers and pass through the pores to the inside of the hollow fiber. In these embodiments, fluid inside the hollow fiber will not include microorganisms, including NTMs, and/or viruses, etc.

As shown for example in FIG. 2, the end cap 108 may define the inlet 110. Fluid 1210 may enter the system 100 through the inlet 110 and leave the system 100 via the aperture 114. In some embodiments, the neck portion 102 may define the inlet 110. In some embodiments, fluid 1210 may enter the system 100 through the neck portion 102.

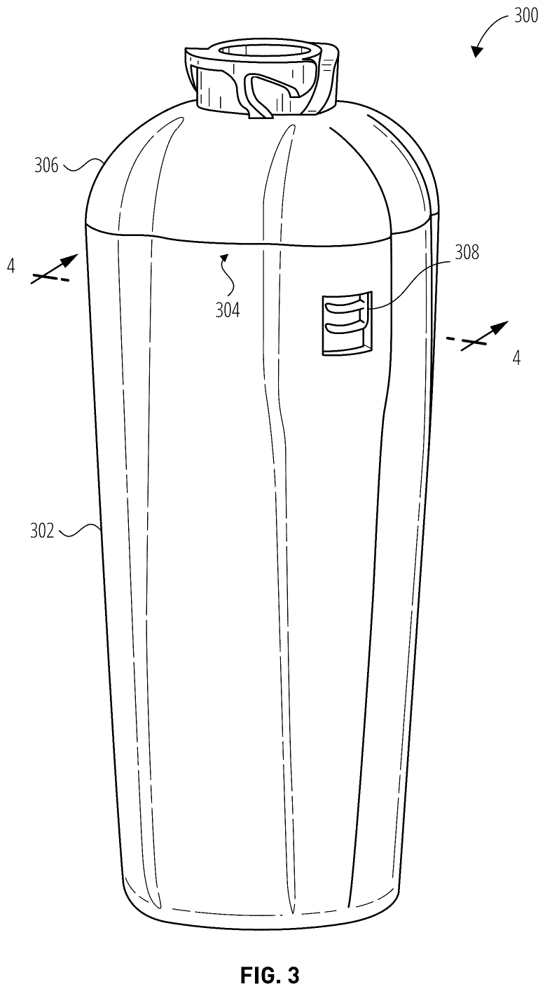

FIG. 3 shows an example of an enclosure system 300, which may include a system 100, an enclosure 302 and a lid portion 306. The system 300 may be adapted to hold and clean a liquid (such as water) using the system 100. In some embodiments, the enclosure 302 may be as described in U.S. patent application Ser. No. 18/119,703, filed Mar. 9, 2023 and entitled DENTAL WATER SUPPLY SYSTEMS AND METHODS,” which is hereby incorporated by reference herein in its entirety and for all purposes. The system 100 may be disposed within the enclosure 302. The enclosure 302 may have a removeable lid portion 306 coupled to the body of the enclosure 302 via a coupling 304. The lid portion 306 and the enclosure 302 may be separable by a release mechanism 308. In some embodiments, the disinfecting agent 214 and the microbial filter 202 may be placed in-line with hose, tubing, etc. of a dental water supply system, rather than in an enclosure, so as to provide cleaning to various branching parts of a water system. In some embodiments, the enclosure 302 and the lid portion 306 may define an interior cavity 402 that may hold a fluid 1202 that has been filtered and disinfected by the system 100. For example, the system 300 may receive a fluid, wherein the fluid is pressurized (e.g., by an air or other pressurized gas), unfiltered, and has not been disinfected, and disposed within the cavity defined by the lid portion 306 and the enclosure 302. For example, a user may decouple the lid portion 306 from the body of the enclosure and may fill the interior cavity with a dental fluid such as water. The user may then recouple the body to the lid portion 306. The system 100 receives the fluid 1210 through the inlet 110. The fluid 1210 may then flow through the end cap 108 and enter the lower portion 106. The fluid 1210 may contact the disinfecting agent 214 while flowing through the lower portion 106, wherein the disinfecting agent 214 disinfects the fluid 1210. The fluid 1210 may then flow to the upper portion 104, wherein the fluid 1210 will flow through the microbial filter 202. Fluid 1210 pressure forces the fluid 1210 to pass through the pores of the microbial filter 202. Microorganisms cannot pass through the pores due to the pore size, effectively producing a permeate of clean fluid 1202 substantially free of target microorganisms, including possibly NTMs. In some embodiments, viruses cannot pass through the pores of the microbial filter 202. The now filtered and disinfected fluid 1202 then flows through the neck portion 102 and exits the system 100 through an aperture 114 defined by the neck portion 102. In some embodiments, the system 100 may initially receive fluid 1210 through the aperture 114 and exit the system 100 through the inlet 110 and accumulate in the interior cavity 402 defined by the lid portion 306 and the enclosure 302.

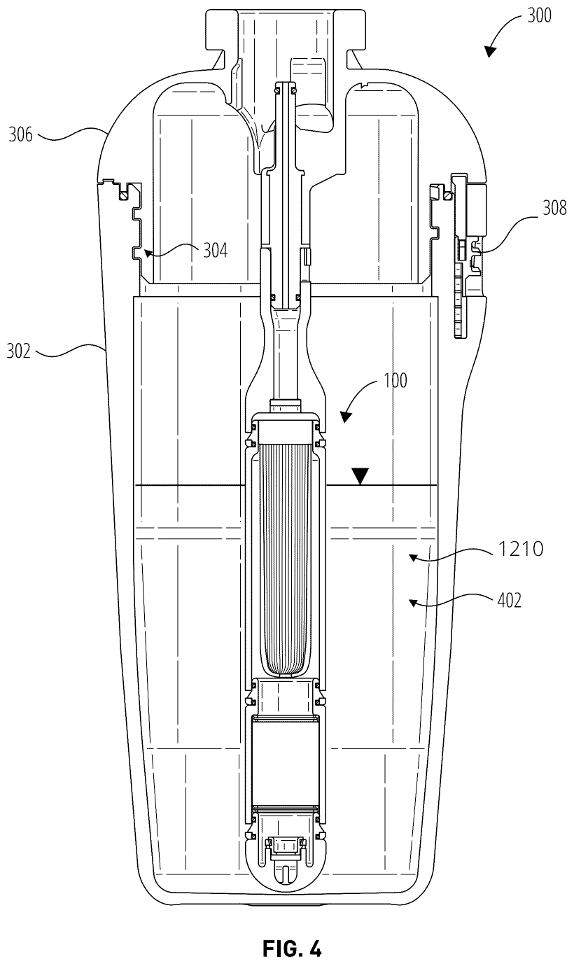

FIG. 4 is a section view of the example system shown in FIG. 3 along line 4-4. Both FIG. 3 and FIG. 4 show an example of the system 300 in a closed state, as the lid portion 306 and the enclosure 302 are coupled together to define a sealed interior cavity. Both FIG. 3 and FIG. 4 also depict an example of a release mechanism 308. When engaged, the release mechanism 308 may at least partially separate the lid portion 306 from the enclosure 302. In some embodiments, the system 100 may couple to the lid portion 306. In some embodiments, the system 100 may couple to the enclosure 302. In some embodiments, the release mechanism 308 may include a slide button, a push button, a handle, or a combination thereof.

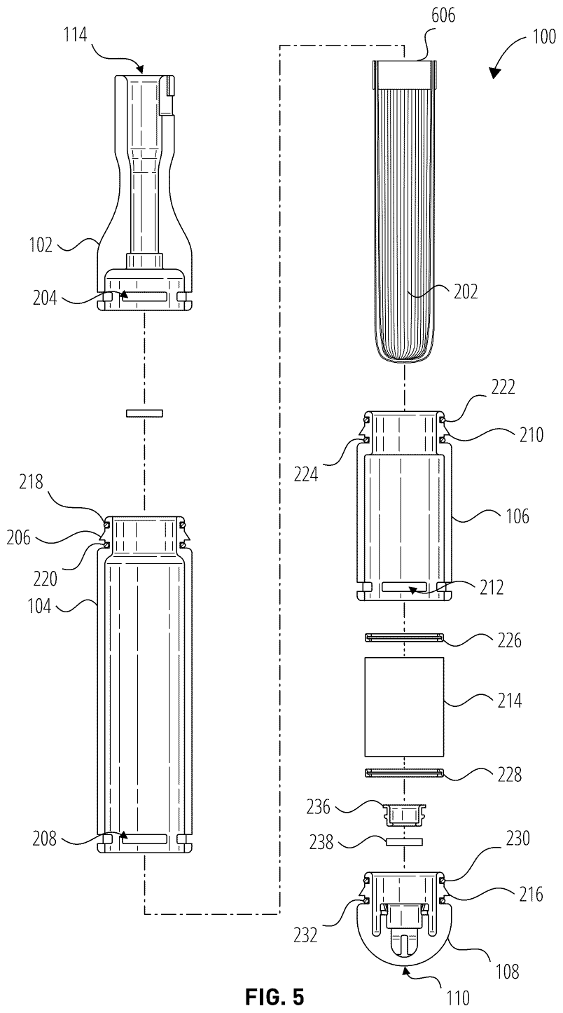

As shown for example in FIG. 5, the system 100 may include a neck portion 102, an upper portion 104, a lower portion 106, an end cap 108, a microbial filter 202, a disinfecting agent 214, a seal 218, a seal 220, a seal 222, a seal 224, a seal 226, a seal 228, a seal 230, and a seal 232.

As shown for example in FIG. 5, the upper portion 104 may define the aperture 114 and the plurality of apertures 204. In some embodiments, the neck portion 102 may define a single aperture 204. The upper portion 104 defines the plurality of tangs 206. In some embodiments, the upper portion 104 may define a single tang 206. The plurality of tangs 206 may engage with the plurality of apertures 204 to couple the neck portion 102 with the upper portion 104. The upper portion 104 also houses the microbial filter 202. In some embodiments, other components of the housing 212 may house the microbial filter 202, such as the lower portion 106.

As shown for example in FIG. 5, the upper portion 104 may define the plurality of apertures 208 and the lower portion 106 defines a plurality of tangs 210. In some embodiments, the upper portion 104 may define a single aperture 208. In some embodiments, the lower portion 106 may define a single tang 210. The plurality of tangs 210 may engage with the plurality of apertures 208 to couple the upper portion 104 to the lower portion 106. In some embodiments, the upper portion 104 may couple with at least another upper portion 104. In some embodiments, the lower portion 106 may couple with another of lower portion 106. In some embodiments, the system 100 may include a combination of at least one of the upper portion 104 and at least one lower portion 106. For example, the system 100 may include a plurality of the upper portion 104 and a plurality of the lower portion 106, alternating between two or more the upper portions 104 and the lower portions 106, and/or microbial filter 202 and disinfecting agent 214. The lower portion 106 houses the disinfecting agent 214. In some embodiments, the upper portion 104 may house the disinfecting agent 214. In some embodiments, the disinfecting agent 214 is combined with the microbial filter 202.

As shown for example in FIG. 5 the lower portion 106 may define a plurality of apertures 212, and the end cap 108 defines a plurality of tangs 216. In some embodiments, the lower portion 106 may define a single aperture 212. In some embodiments, the end cap 108 may define a single tang 216. The plurality of tangs 216 may engage with the plurality of apertures 212 to couple the lower portion 106 to the end cap 108. As shown for example in FIG. 5, the end cap 108 may define the inlet 110.

As shown for example in FIG. 5, the seal 218 and the seal 220 may be disposed within an interface between the neck portion 102 and the upper portion 104. The seal 218 and the seal 220 may prevent fluid 1210 flow other than fluid 1210 flow between the neck portion 102 and the upper portion 104. The seal 218 and the seal 220 may prevent fluid 1210 flowing through the neck portion 102 and the upper portion 104 from contaminating or being contaminated with another fluid 1210, e.g., fluid held within the interior cavity defined by the enclosure 302 and the lid portion 306. In some embodiments, the seal 218 and the seal 220 may include o-rings, gaskets, compression seals, cam lock seals, or combinations thereof.

As shown for example in FIG. 5, the seal 222 and the seal 224 may be disposed within the interface between the interface between the upper portion 104 and the lower portion 106. The seal 222 and the seal 224 may prevent fluid flow other than fluid flow between the upper portion 104 and the lower portion 106. The seal 222 and the seal 224 may prevent fluid flowing through the upper portion 104 and the lower portion 106 from contaminating or being contaminated with another fluid, e.g., fluid held within the interior cavity defined by the enclosure 302 and the lid portion 306. In some embodiments, the seal 222 and the seal 224 may include o-rings, gaskets, compression seals, cam lock seals, or combinations thereof.

As shown for example in FIG. 5, the seal 226 and the seal 228 may be disposed within the lower portion 106. The seal 226 and the seal 228 may prevent the disinfecting agent 214 from moving into a different component of the housing 112. In some embodiments, the seal 226 and the seal 228 may prevent fluid flow other than fluid flow from the lower portion 106 to either the upper portion 104 or the end cap 108. The seal 226 and the seal 228 may prevent the fluid moving through the lower portion 106 from contaminating or being contaminated by another fluid. In some embodiments, the seal 226 and the seal 228 may include a screen, a mesh, permeable membranes, gaskets, flanges, o-rings, compression seals, cam lock seals, or combinations thereof.

As shown for example in FIG. 5, a seal 230 and a seal 232 may be disposed within the interface between the lower portion 106 and the end cap 108. The seal 230 and the seal 232 may prevent fluid flow other than fluid moving between the lower portion 106 and the end cap 108. The seal 230 and the seal 232 may prevent the fluid moving between the lower portion 106 and the end cap 108 from contaminating or being contaminated another fluid. In some embodiments, the seal 230 and the seal 232 may include o-rings, gaskets, compression seals, cam lock seals, or combinations thereof.

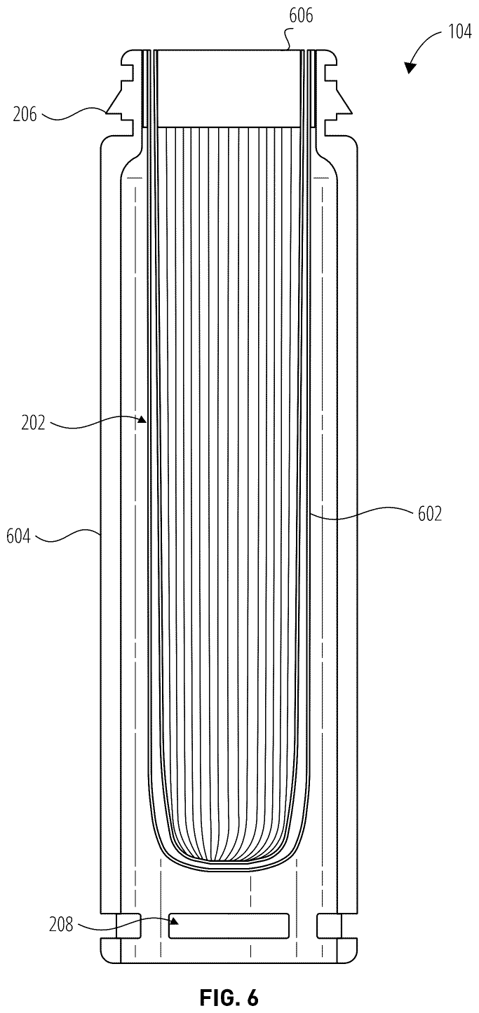

FIG. 6 shows an example of the microbial filter 202 housed in an example of the upper portion 104. The microbial filter 202 includes a plug 606 and a plurality of hollow fiber 602. In some embodiments, the microbial filter 202 does not include a plug 606. In some embodiments, the upper portion 104 may include the plug 606. The plug 606 may maintain fluid pressure within the microbial filter 202. The plug 606 receives and holds ends of the hollow fiber 602. The plug 606 blocks flow of the fluid therethrough and causes fluid to flow through the walls of the hollow fiber 602 (see, e.g., FIGS. 12A and 12B and related description). In some embodiments, the microbial filter 202 may include filtration materials other than the hollow fiber 602. Such filtration materials may include other membrane materials. Examples of other membranes include polymer membranes, ceramic membranes, zeolite membranes, crystalline membranes, nanostructure membranes, or combinations thereof.

As shown for example in FIG. 6, the upper portion 104 may define a plurality of tangs 206 and a plurality of apertures 208. The plurality of tangs 206 may engage with a plurality of apertures from a different component of the housing 212, such as the neck portion 102, another of the upper portion 104, or the lower portion 106, to couple with said housing component. For example, the plurality of tangs 206 may engage with the plurality of apertures 204 by inserting the upper portion 104 into the neck portion 102 with enough force that the plurality of tangs 206 snap into the plurality of apertures 204.

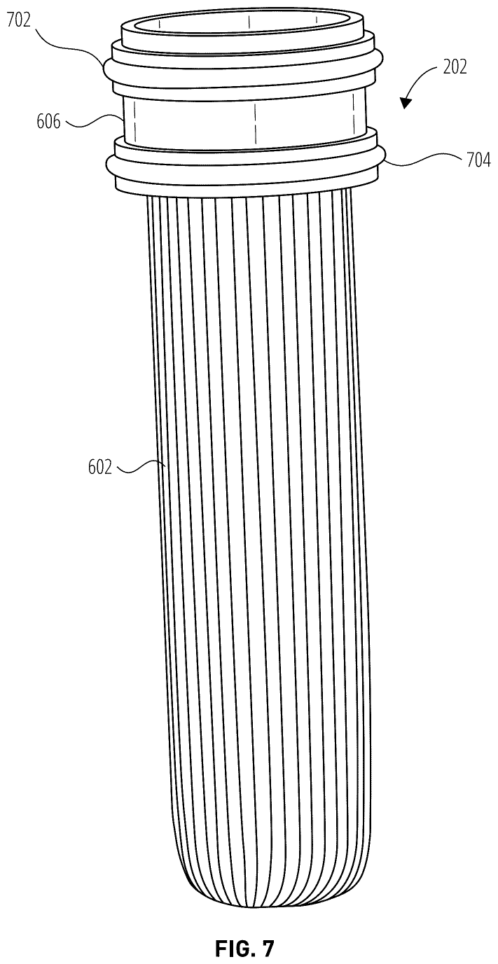

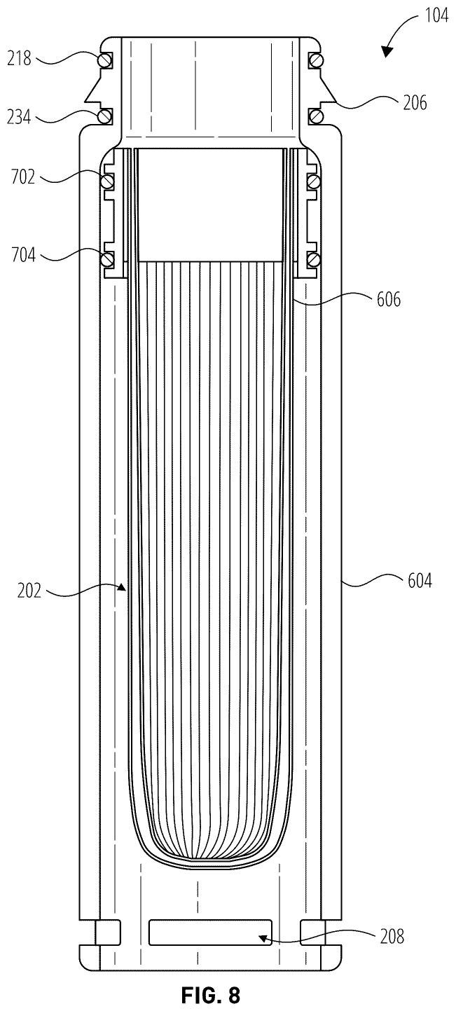

Both FIG. 7 and FIG. 8 show another embodiment of the microbial filter 202. FIG. 8 shows an embodiment of the microbial filter 202 housed in the upper portion 104. As shown for example in FIG. 7 and FIG. 8, the microbial filter 202 may include a seal 702 and a seal 704, as well as a plug 606 and a plurality of hollow fiber 602. The seal 702 may compress between the surface of a wall 604 and the microbial filter 202 to prevent fluid flow from one side of the seal 702 to the other. Similarly, the seal 704 may compress between the surface of the wall 604 and the microbial filter 202 to prevent fluid flow from one side of the seal 704 to the other. The plurality of seals, such as the seal 702 and the seal 704 may prevent fluid 1210 flow in the event one of the seals, such as if seal 704, breaks or deforms. By preventing fluid 1210 flow, the seal 702 and the seal 704 may prevent microorganisms and/or viruses from moving from the upper portion 104 to another compartment the upper portion 104 couples to, such as the neck portion 102. As shown for example in both FIG. 7 and FIG. 8, the plug 606 may be disposed adjacent to an end of the microbial filter 202 where the upper portion 104 couples to another component of the housing 212, such as the neck portion 102 (not shown). In other embodiments, the plug 606 may be disposed on an adjacent end of the microbial filter 202, or disposed by a coupling with a different compartment, e.g., the plug 606 may be disposed on the end of the microbial filter 202 where the upper portion 104 couples to the end cap 108. The plug 606 may maintain fluid pressure within the microbial filter 202. As shown in FIG. 8, the microbial filter 202 may be disposed within the wall 604.

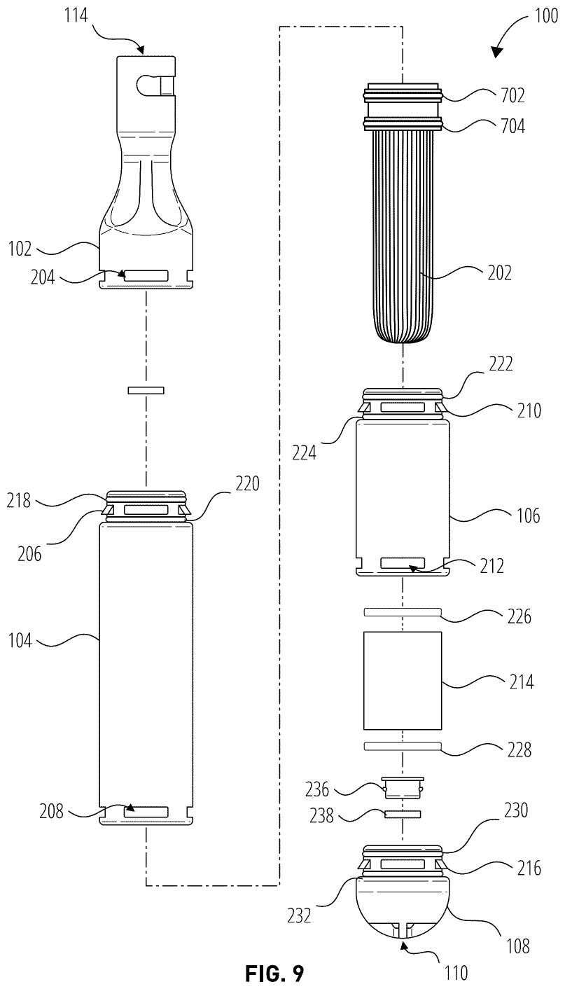

FIG. 9 shows a partially exploded elevation view of an embodiment of system 100 which includes the embodiments of the microbial filter 202 shown in FIG. 7 and FIG. 8. The system 100 may include a neck portion 102, an upper portion 104, a lower portion 106, an end cap 108, a microbial filter 202, a disinfecting agent 214, a seal 218, a seal 220, a seal 222, a seal 224, a seal 226, a seal 228, a seal 230, a seal 232, a seal 234, a seal 702, and a seal 704.

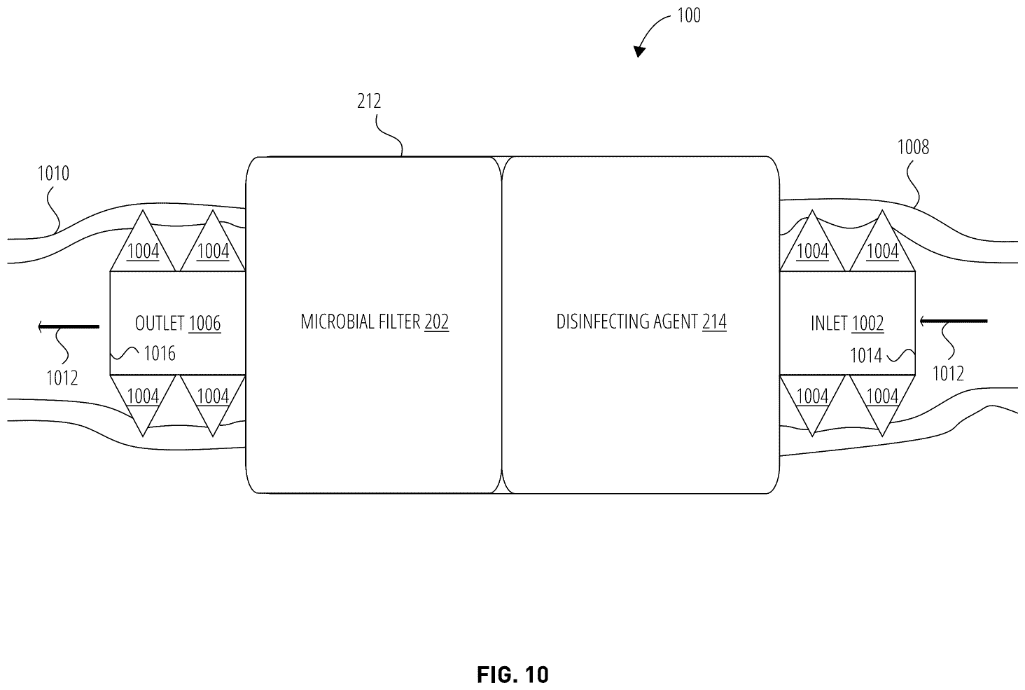

FIG. 10 shows an embodiment of the system 100 suitable for placing inline in a pipe, tube, or other conduit of a dental water system. The system 100 may be disposed in line with a fluid flow path 1012. For example, the system 100 may be disposed between piping or hose such as an inlet tube 1008 and an outlet tube 1010, as shown for example in FIG. 10. The system may include a microbial filter 202 and a disinfecting agent 214 housed within a housing 212. The housing 212 may define one or more of a protrusion 1004, an inlet 1002, an outlet 1012. The protrusion 1004 may partially deform a material defining a flow path of dental supply fluid, such a tubing or hose, when inserted in the material. By partially deforming the material, the protrusion 1004 secures the position of the system 100, and may prevent fluid 1210 flow around the protrusion 1004. In some embodiments, a clamp positioned over the protrusion 1004 and tightened may further secure the position of the system 100 and prevent fluid flow around the protrusion 1004. In some embodiments, the protrusion 1004 may form threading, allowing the system 100 to screw into a tube, hose, or piping, to secure its position and prevent fluid flow around the protrusion. The inlet 1002 defines an aperture 1014 that a contaminated fluid may flow through to contact with the disinfecting agent 214. The fluid that contacts the disinfecting agent 214 may then flow through the microbial filter 202. A cleaned fluid 1202 may flow from the microbial filter 202 through an aperture 1016 defined by the outlet 1012. In some embodiments, the fluid flow path may flow in an opposite direction, e.g., flowing a contaminated fluid 1210 through the outlet 1012 to flow through the microbial filter 202, then through the disinfecting agent 214, and exit the system 100 through the inlet 1002. In some embodiments, the one or more of the protrusions 1004, the inlet 1002, and the outlet 1012 are separate from the housing 212, i.e., they are separate components the housing 212 does not define.

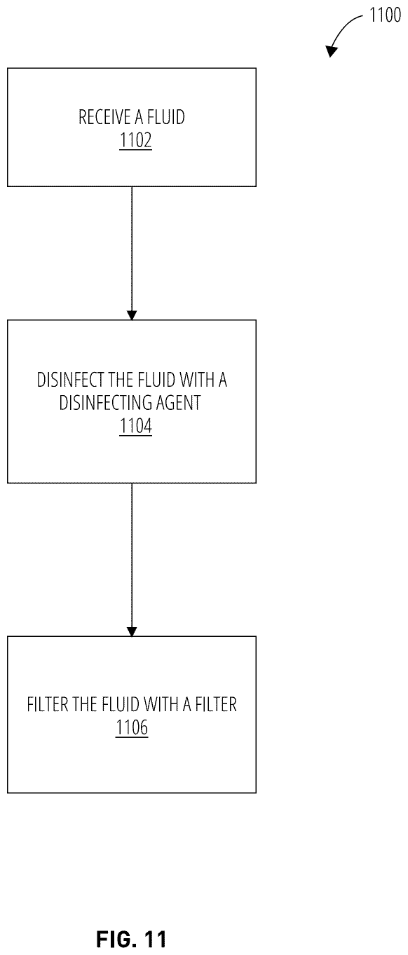

FIG. 11. shows a flow chart of an example of the method 1100 of using any of the disclosed systems for cleaning a dental water supply disclosed herein, such as the system 100 and the system 300. Although the example flow chart depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence. The method may clean a fluid 1210 in preparation for dental work. The method 1100 may include an operation 1102, receiving a fluid 1210. In some embodiments, receiving the fluid 1210 may include flowing fluid 1210 into a cavity defined by the system, such as the interior cavity 402, and placing the fluid 1210 under greater than atmospheric pressure. The greater than atmospheric pressure may then move the fluid 1210 from the cavity through the system 100. In some embodiments, a negative pressure, for example a vacuum, may draw the fluid 1210 from the interior cavity through the system 100. In some embodiments, receiving the fluid 1210 may include connecting a pipe, tube, or hose to the system 100. The method 1100 may include an operation 1104, disinfecting the fluid 1210. Disinfecting the fluid 1210 may include contacting the fluid 1210 with at least one of iodine, silver, copper, titanium, chlorine dioxide, chlorhexidine gluconate, hydrogen peroxide, cetylpyridinium chloride, or combinations thereof. In some embodiments, the method 1100 may repeat the operation 1104 multiple times. The method 1100 may include an operation 1106, filtering the fluid 1210 with a filter. In some embodiments, filtering the fluid 1210 includes flowing the fluid 1210 while preventing microorganisms, including possibly NTMs, and/or viruses from moving past a filter. In some embodiments, the filter is a microbial filter 202 included in the system 100, and may include a plurality of hollow fiber 602, or other membranes described herein. In some embodiments, the method 1100 may repeat the operation 1106 multiple times. In some embodiments, the method 1100 may alternate repetitions of the operation 1104 and the operation 1106. In some embodiments, the operation 1106 may be executed before the operation 1104. In some embodiments, the operations 1104 and 1104 may be performed in parallel with one another.

FIG. 12A and FIG. 12B show different arrangements that an example of the microbial filter 202 may use to filter a contaminated fluid 1210. The filtered fluid is represented as a cleaned fluid 1202. The microbial filter 202 may include a plurality of a hollow fiber 602. FIG. 12A and FIG. 12B both show examples of one of the plurality of the hollow fiber 602. The hollow fiber 602 includes a lumen 1204 and a wall 1206. In one arrangement, as shown for example in FIG. 12A, the contaminated fluid 1210 in the system 100 is received outside of the wall 1206 of the hollow fiber 602. The contaminated fluid 1210 may pass through the wall 1206 of the hollow fiber 602 and then out through a lumen 1204 thereof, being filtered in the process into a cleaned fluid 1202. In another arrangement, as shown for example in FIG. 12B, the contaminated fluid 1210 in the system 100 may pass into the lumen 1204 of the hollow fiber 602 and then out through a wall 1206 thereof, being filtered in the process into a cleaned fluid 1202. In some embodiments, the contaminated fluid 1210 is pressurized. In some embodiments, the wall 1206 contains a plurality of pores, defining a pore size. Pressure drives fluid through the pores, while the pore size prevents microorganisms, including NTMs, from flowing through the wall 1206. In both examples depicted in FIG. 12A and FIG. 12B, the microorganisms disclosed herein may be trapped in the wall 1206 and effectively removed from the cleaned fluid 1202.

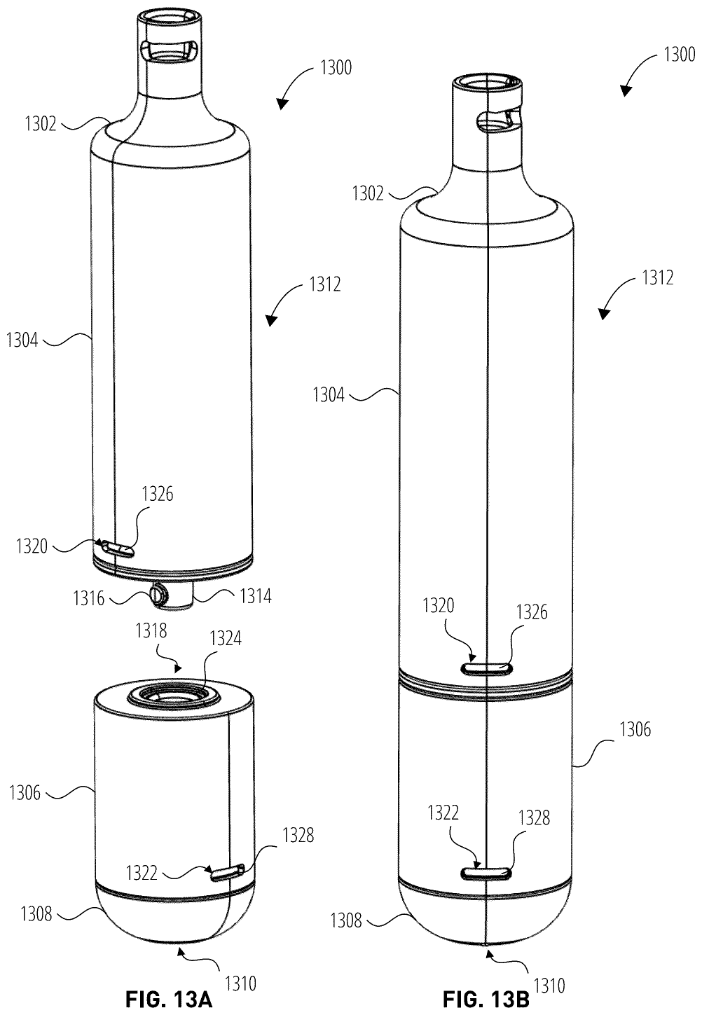

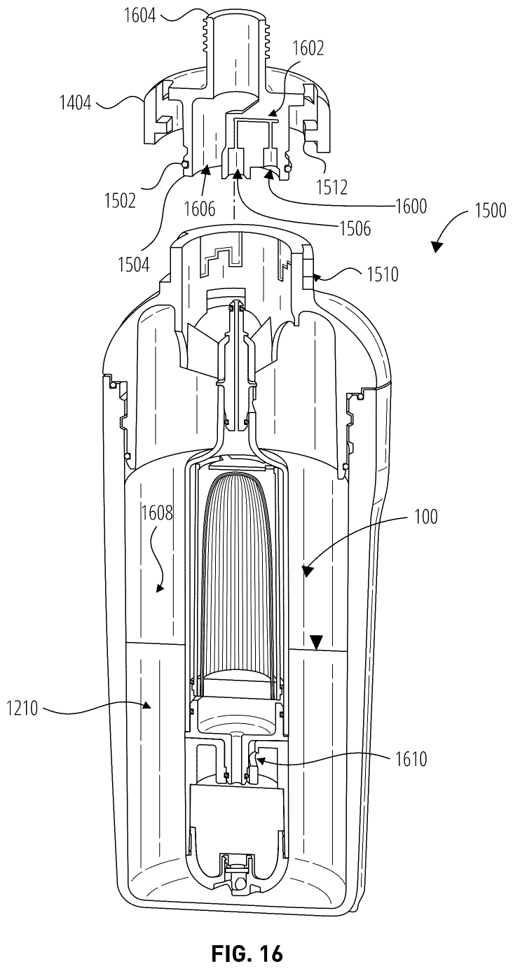

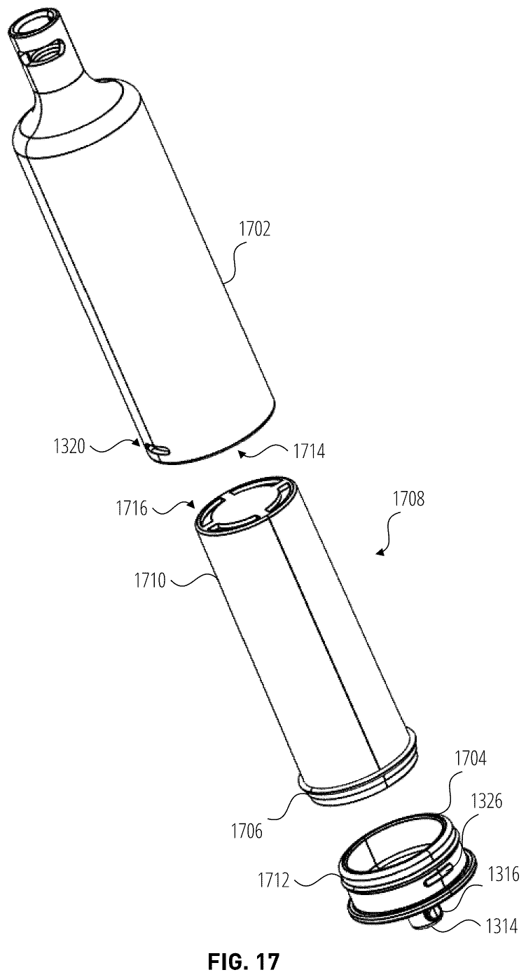

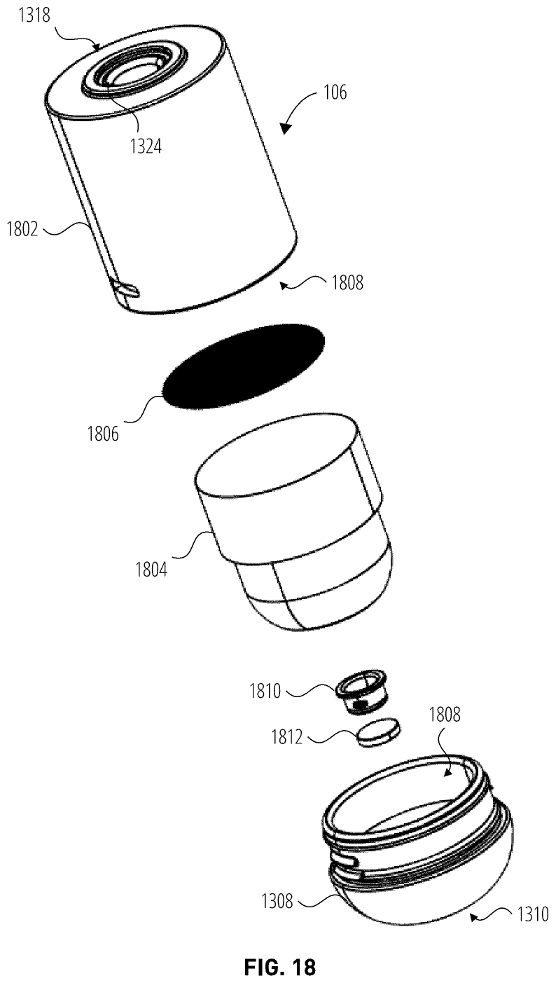

FIG. 13A is a partially exploded view of an embodiment of a system 1300 for cleaning a dental water supply. Like the system 100, the system 1300 includes a disinfecting agent and a microbial filter similar to those used in the system 100. For example, the system 1300 includes a disinfecting agent 1804 (e.g., iodine resin beads or granules), and a microbial filter suitable to filter protists such as NTMs, viruses, bacterial, etc. For example, the microbial filter may include a hollow fiber filter similar to that described with respect to the system 100. The system 1300 may include a neck portion 1302, an upper portion 1304, a lower portion 1306, and an end cap 1308. The upper portion 1304 may house a microbial filter 1708, as shown for example in FIG. 17. The lower portion 1306 may house a disinfecting agent 1804, as shown for example in FIG. 18. The components of the housing 1312 may couple together by a, a twist and lock mechanism, as shown for example in FIG. 13A, or by a snap-fit mechanism as described with respect to the system 100. The upper portion 1304 may include an extension 1314, which defines a boss 1316. The upper portion may include an aperture 1320. The lower portion 1306 may define an aperture 1318 through an upper face thereof. The lower portion 1306 may also include an aperture 1322 through a sidewall thereof. The aperture 1318 may further define a channel 1610, or groove (shown for example in FIG. 16). The extension 1314 may be inserted into the aperture 1318 by aligning the boss 1316 with the groove defined by the aperture 1318. Once the upper portion 1304 is inserted in the lower portion 1306, the upper portion 1304 may be rotated until the boss 1316 reaches the end of the groove, thus, forming a fluid tight engagement. The lower portion 1306 may also include a seal 1324. Once the upper portion 1304 and the lower portion 1306 are coupled, the seal 1324 may compress against a surface of the upper portion 1304. By compressing, the seal 1324 prevents fluid 1210 from leaking where the upper portion 1304 couples to the lower portion 1306. In some embodiments, a seal may be disposed on the extension 1314. In some embodiments, the upper portion 1304 may couple with another of the upper portion 1304 with the twist and lock mechanism. In some embodiments, multiples of the upper portion 1304 and the lower portion 1306 may couple together with the twist and lock mechanism shown for example in FIG. 13A. In some embodiments, an example of the upper portion 1304 shown in FIG. 13A may couple with another of the upper portion 1304, and an example of a lower portion 1306 shown in FIG. 13A may couple with another of the lower portion 106.

As shown for example in FIG. 13A, the upper portion 1304 may be formed as a unitary piece with the neck portion 1302. In some embodiments, the upper portion 1304 and the neck portion 1302 may be fused together from separate portions into a single assembly. In some embodiments, the neck portion 1302 is a separate part that may couple with the upper portion 1304 (e.g., as described with respect to the system 100).

FIG. 13B is an isometric view of the system 1300 of FIG. 13A with the upper and lower portions coupled together. As shown from FIG. 13B, the aperture 1320 of the upper portion 1304 aligns with the aperture 1322 of the lower portion 1306 when the upper portion 1304 couples and engages with the lower portion 1306. Alignment of the aperture 1320 and the aperture 1322 may indicate the upper portion 1304 engaged with the lower portion 1306, and that a fluid tight seal has been formed between the upper portion and lower portion.

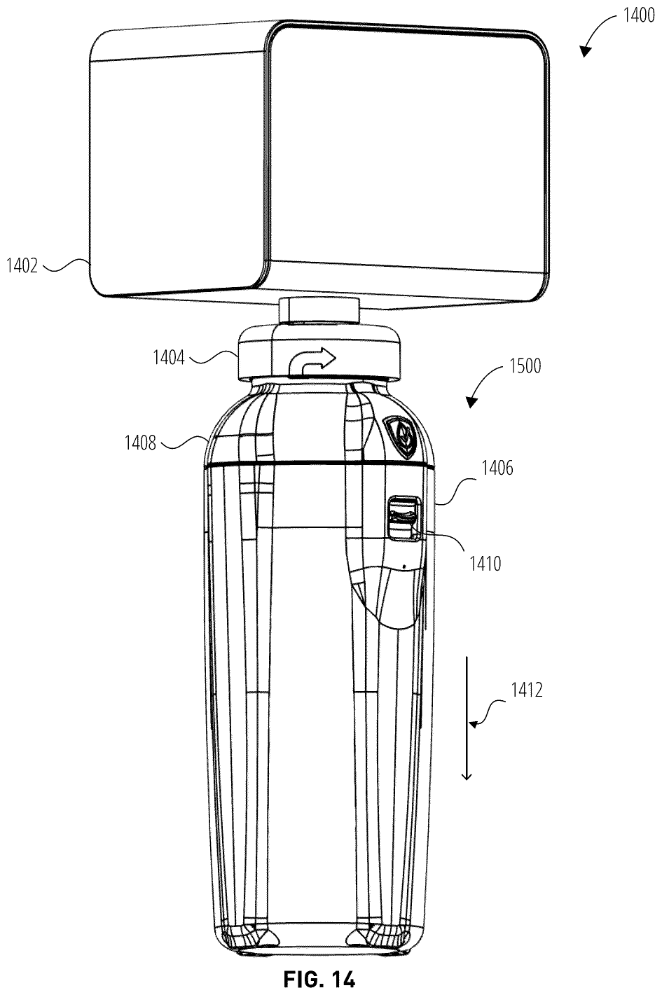

FIG. 14 shows an example of a system 1400. As shown for example in FIG. 14, the system 1400 may include an enclosure system 1500 suitable for use with the system 100 and/or 1300 disclosed herein. The system 1400 may couple to a dental water supply 1402. The enclosure system 1500 is similar to the enclosure system 300 as described herein. The enclosure system 1500 may include an enclosure 1406, a lid portion 1408, and a release mechanism 1410. The system 1400 may also include a collar 1404, and a dental water supply 1402. The collar 1404 may couple to the dental water supply 1402. The collar 1404 may also couple to the lid portion 1408. The lid portion 1408 and the enclosure 1406 may couple together and define an internal compartment 1608. The internal compartment 1608 may receive a system 100 or system 1300. However, the housing 1312 of the system 1300 may couple differently than the housing 112 of the system 100, as discussed in more detail herein. The microbial filter 1708 of the system 1300 may also be arranged differently than the microbial filter 202 of the system 100. The disinfecting agent 1804 may be arranged differently than the disinfecting agent 214. In some embodiments, the system 1300 may include the microbial filter 202. The system 1300 includes a microbial filter 1708, such as a hollow fiber filter. In some embodiments, the system 1300 may include the disinfecting agent 214. In some embodiments, the system 1300 may include the disinfecting agent 214. The dental water supply 1402 may provide a gas to the internal compartment 1608, as shown for example in FIG. 16, which may pressurize the system 1500, driving contaminated fluid 1210 through the system 1500 to be filtered and purified by the system 100 or 1300 disposed therein. The system 1400 may also provide a flow path for the fluid 1210 cleaned by the system 1500.

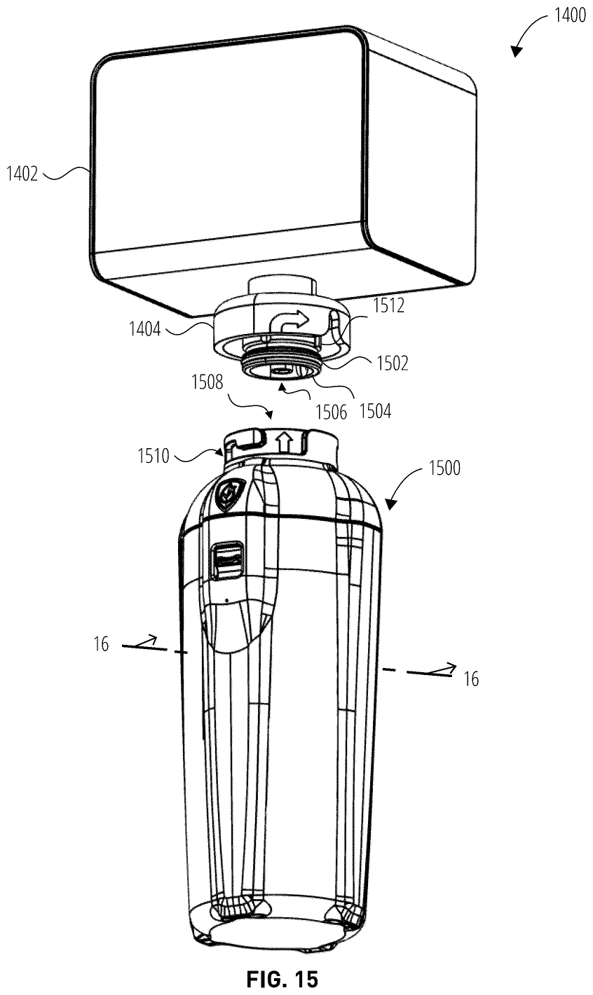

FIG. 15 is a partially exploded view of an example of the system 1400 of FIG. 14. As shown for example in FIG. 15, the collar 1404 may include an extension 1504 protruding from the center of the collar 1404. A seal 1502 may seat on the outer surface of the extension 1504. The extension 1504 may define a securement feature 1512, described in more detail herein. The lid portion 1408 may define an aperture 1508, as well as a channel 1510. By inserting and rotating the extension 1504 within the aperture 1508, the securement feature 1512 may engage with the channel 1510, coupling the collar 1404 with the system 1500. The seal 1502 may compress against an outer surface of the extension 1504 and an inner surface of the aperture 1508, forming a fluid tight engagement. In some embodiments, the extension 1504 and the lid portion 1408 may include snap and fit features, apertures receivable by fasteners, threading, or combinations thereof, to couple the collar 1404 to the system 1500. The collar 1404 may also define an inlet aperture 1506. The collar 1404 may also couple with the system 1500 by at least one of a securement feature 1512 and a channel 1510 described in more detail herein.

The system 1500 may clean fluid 1210 in a similar fashion to the system 300. Fluid 1210 may at least partially fill an internal compartment 1608, as shown for example in FIG. 16. Fluid 1210 may flow from the internal compartment 1608 through the inlet 1310 to enter the system 1300, which may then clean and/or filter the fluid 1210. The cleaned fluid 1202 may exit the system 1300 through the neck portion 1302 and into the system 1500, through a flow path defined by the interior of the neck portion 1302 coupled to the system 1500. Fluid may enter the system 1400 by flowing into the collar 1404 from the system 1500 through the inlet aperture 1506.

FIG. 16 is a section view of examples of the collar 1404 and the system 1500. The collar 1404 may define at least one of a securement feature 1512. The system 1500 may define a channel 1510. As shown for example in FIG. 16, the securement feature 1512 may engage with the system 1500 to secure the collar 1404 to the system 1500. For example, the collar 1404 may engage with the system 1500 by inserting the securement feature 1512 in the channel 1510 and locking the collar 1404 in place by twisting, or rotating, until the securement feature 1512 forms a fluid tight engagement with the channel 1510, i.e., a twist a lock mechanism.

In some embodiments, the securement feature 1512 forms a boss, or a protrusion from the interior surface of the collar 1404. In some embodiments, the extension 1504 may define the securement feature 1512. In some embodiments, the securement feature 1512 may include threading, apertures receivable for fasteners, snap and fit features, or combinations thereof.

A seal 1502 may prevent leaks from where the collar 1404 couples to the system 1500. The seal may compress between the surface of the collar 1404 and the surface of the system 1500, preventing leaks. In some embodiments, the seal 1502 is disposed on the surface of the extension 1504, as shown for example in FIG. 16. In some embodiments, the seal 1502 is disposed within the system 1500.

The collar 1404 may include an extension 1604. The extension 1604 may define threading, as shown for example in FIG. 16. By inserting and rotating the collar 1404 into the dental water supply 1402 (an example is shown in FIG. 15), the collar 1404 and the dental water supply 1402 may couple together and form a fluid-tight engagement. In some embodiments, the extension 1604 may include twist and lock features, snap and fit features, apertures receivable by fasteners, or combinations thereof.

The collar 1404 may define a flow path 1602. The inlet aperture 1506 may fluidly communicate with an outlet aperture 1600, through the flow path 1602 defined by the collar 1404. Once the system 1500 couples to the collar 1404, fluid cleaned by the system 1500 may flow through the inlet aperture 1506 to the outlet aperture 1600.

The collar 1404 may also define a lumen 1606. Fluid, such as air, may flow through lumen 1606 and pressurize the interior internal compartment 1608 of the system 1500. In some embodiments, nitrogen gas, carbon dioxide or other gases or combinations thereof pressurize the system 1500.

FIG. 17 is a partially exploded isometric view of an example of the upper portion 1304 of FIG. 13A and FIG. 13B that contains the microbial filter 1708. As shown for example in FIG. 17, the upper portion 1304 may include a housing 1702 and an end portion 1704. In some embodiments, the housing 1702 and the neck portion 1302 may form a unitary body, as shown for example in FIG. 17. In some embodiments, the housing 1702 and the neck portion 1302 form separate bodies, similar to the embodiments shown in FIG. 5. The housing 1702 may couple with the end portion 1704 by aligning the aperture 1320 with the tang 1326, and inserting the end portion 1704 into the housing 1702. The aperture 1320 may receive the tang 1326, securing the end portion 1704 to the housing 1702.

When coupled, the housing 1702 and the end portion 1704 define an interior cavity 1714, which may house an embodiment of the microbial filter 1708. The microbial filter 1708 may include a filter housing 1710 and a seal 1706. Fluid 1210 may enter the interior of the housing 1702 through an aperture defined by the end portion 1704. The fluid 1210 may then immerse the microbial filter 1708, which filters the fluid as described herein. The seal may compress between the filter housing 1710 and the end portion 1704, preventing fluid leaks where the filter housing 1710 and the end portion 1704 couple. The filtered fluid 1202 may then flow through one or more of an aperture 1716 defined by the filter housing 1710, and through the neck portion 1302. In some embodiments, the microbial filter 1708 does not include a filter housing 1710. In some embodiments, the housing 1702 and microbial filter 1708 may clean fluid as a stand-alone unit. For example, the end portion 1704 may define an inlet 1310, and the housing 1702 may couple with the system 1500. In some embodiments, the housing 1702 may couple in line with a fluid supply. In some embodiments, the housing 1702 may house a disinfecting agent 1804. In some embodiments, the housing 1702 may house a combination of the disinfecting agent 1804 and the microbial filter 1708. In some embodiments, fluid may enter from the neck portion 1302 and flow through at least one of the microbial filter 1708 or the disinfecting agent 1804, and through the end portion 1704.

FIG. 18 is a partially exploded isometric view of the example of the lower portion 1306 and the end cap 1308 of the system 1300, shown in FIG. 13A and FIG. 13B. The lower portion 1306 may include a housing 1802. The housing 1802 and the end cap 1308 may define an interior cavity 1808 when coupled together, which may house a disinfecting agent 1804. In some embodiments, the disinfecting agent 1804 may include beads or granules of iodine resin. In some embodiments, the disinfecting agent 1804 may include one or more of silver, copper, titanium, chlorine dioxide, chlorhexidine gluconate, hydrogen peroxide, cetylpyridinium chloride, or combinations thereof. The disinfecting agent 1804 may be disposed at least partially in the end cap 1308. In some embodiments, the disinfecting agent 1804 may be disposed within the lower portion 1306, similar to the example shown in FIG. 2. In some embodiments, the housing 1802 and the end cap 1308 may house a charcoal filter. Fluid may flow through the inlet 1310 into the interior cavity defined by the end cap 1308 and the housing 1702. The fluid may then contact the disinfecting agent 1804, which may kill microorganisms, including possibly NTMS, and/or viruses. The fluid may then exit the housing 1802 through the aperture 1318.

A screen 1806 may prevent the disinfecting agent 1804 from moving into the upper portion 1304. In some embodiments, the screen 1806 may include stainless steel, polymers, metal, metal alloys, ceramics, or combinations thereof. A retaining ring 1810 may prevent the disinfecting agent 1804 from moving out of the system 1300 through the end cap 1308. The retaining ring 1810 may lock into the end cap 1308, and may define an aperture smaller than the disinfecting agent 1804, thus preventing the disinfecting agent 1804 from escaping through the end cap 1308. In some embodiments, a disinfecting housing, or a screen similar to screen 1806, or combinations thereof, may prevent the disinfecting agent 1804 from escaping through the end cap 1308. The retaining ring 1810 may seat a porous media 1812. The porous media 1812 may filter fluid flowing through the inlet 1310 defined by the end cap 1308. The porous media 1812 may prevent solid particles from entering the system 1300. In some embodiments, the porous media 1812 includes a sintered polymer. In some embodiments, the porous media 1812 may include steel, metal, metal alloys, polymers, ceramics, or a combination thereof. In some embodiments, the housing 1802 and the end cap 1308 may clean water as a stand-alone unit. For example, the housing 1802 may couple to the system 1500 to disinfect water. In some embodiments, the housing 1802 and end cap 1308 may house a microbial filter 202. In some embodiments, the housing 1802 and end cap 1308 may house a combination of the microbial filter 1708 and the disinfecting agent 1804. In some embodiments, the housing 1802 and the end cap 1308 may form a single unitary body. In some embodiments, fluid may flow through the top of the housing 1802 and through the bottom of the end cap 1308.

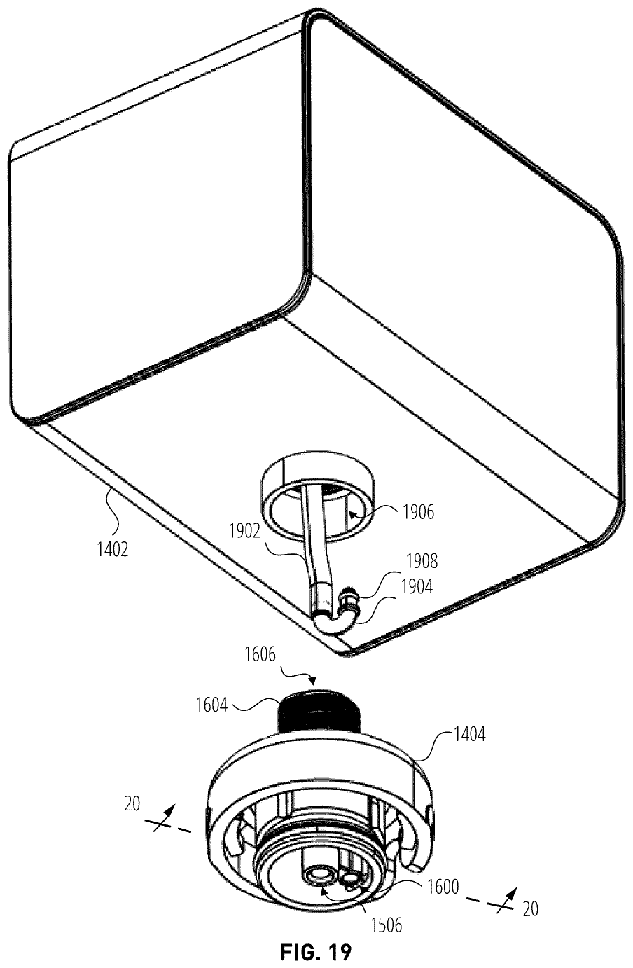

FIG. 19 is a partially exploded view of an example of the dental water supply 1402 and the collar 1404. The dental water supply 1402 may receive a conduit 1902. One on end, the conduit 1902 may include an adaptor 1904 and a seal 1908. The conduit 1902 may extend through an aperture 1906, defined by the dental water supply 1402. The conduit 1902 may extend through the lumen 1606 and couple to the outlet aperture 1600 via engagement with the adaptor 1904. In some embodiments, the conduit 1902 includes tubing, pipe, hose, or combinations thereof. In some embodiments, the conduit 1902 includes polymer, metal, steel, or combinations thereof. Fluid may flow from the system 1500 to the conduit 1902 through the inlet aperture 1506, the flow path 1602, and the outlet aperture 1600. The seal 1908 may prevent fluid from leaking from where the adaptor 1904 couples to the outlet aperture 1600. In some embodiments, the adaptor 1904 may form a hook shape. The hook shape of the adaptor 1904 has many advantages. For example, the hooked adaptor 1904 facilitates assembly of the collar 1404 with the dental water supply 1402. The conduit 1902 can be passed through the lumen 1601. The collar 1404 can be threadedly coupled to the dental water supply 1402, and the adaptor 1904 received in a terminal end of the flow path 1602. The system 100 or 1300 may then pass cleaned fluid 1202 to the dental water supply via the conduit 1902, and ultimately to a dental tool.

In some embodiments, the outlet aperture 1600 may face downward along the vertical axis 1412 of the system 1500. In some embodiments, the conduit 1902 may couple to the outlet aperture 1600. However, the conduit 1902 may form a bend to couple to the outlet aperture 1600 facing downward, which may compromise the security of the coupling due to the recoil or tension of the conduit 1902 exerting a force on the terminal end of the conduit 1902 away from the outlet aperture 1600. By coupling the conduit 1902 to the outlet aperture 1600 with the adaptor 1904, less recoil force is exerted on the terminal end of the conduit 1902 than coupling the conduit 1902 to the outlet aperture 1600 without the adaptor 1904. In some embodiments, the conduit 1902 may form the adaptor 1904. In some embodiments, the adaptor 1904 includes a different material than the conduit 1902. For example, the adaptor 1904 may include a polymer different than a polymer included in the conduit 1902. In some embodiments, the adaptor 1904 may couple to the conduit 1902 by at least being partially inserted into the conduit 1902. In some embodiments, a clamp may secure the adaptor 1904 to the conduit 1902.

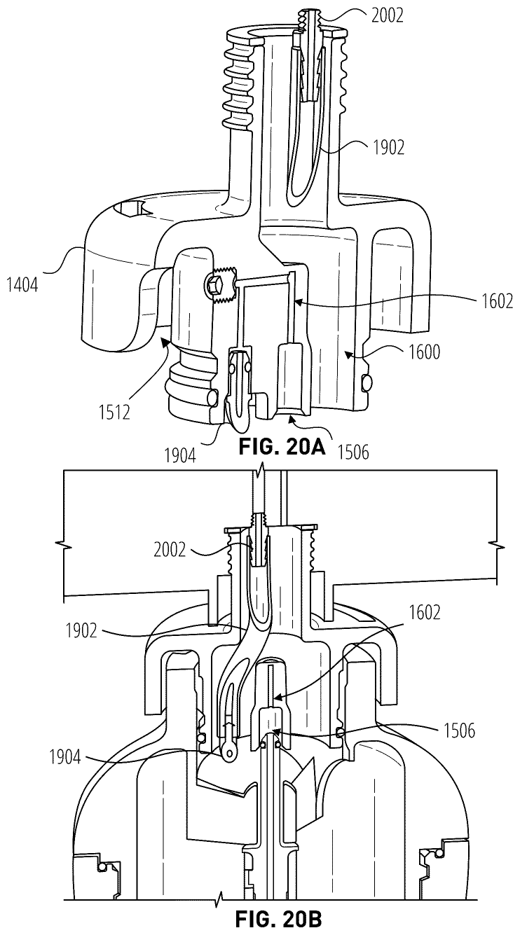

FIG. 20A is a partial section view of an example of the collar 1404 coupled to the dental water supply 1402. As shown for example in FIG. 20A, the conduit 1902 may couple with the outlet aperture 1600.

FIG. 20B is a partial section view of an example of the collar 1404 coupled to the system 1500 and the dental water supply 1402. Fluid cleaned by the system 1500 may flow through the inlet aperture 1506, and the flow path 1602. After flowing through the outlet aperture 1600, the cleaned fluid may enter the conduit 1902. The conduit 1902 may extend into the dental water supply 1402. As shown for example in FIG. 20B, the conduit 1902 may couple to a barb 2002. The barb 2002 may couple to a different conduit than the conduit 1902. In some embodiments, the conduit 1902 does not couple with a barb 2002 and forms the conduit extending through the dental water supply 1402 and supply the cleaned fluid to one or more dental tools or systems.

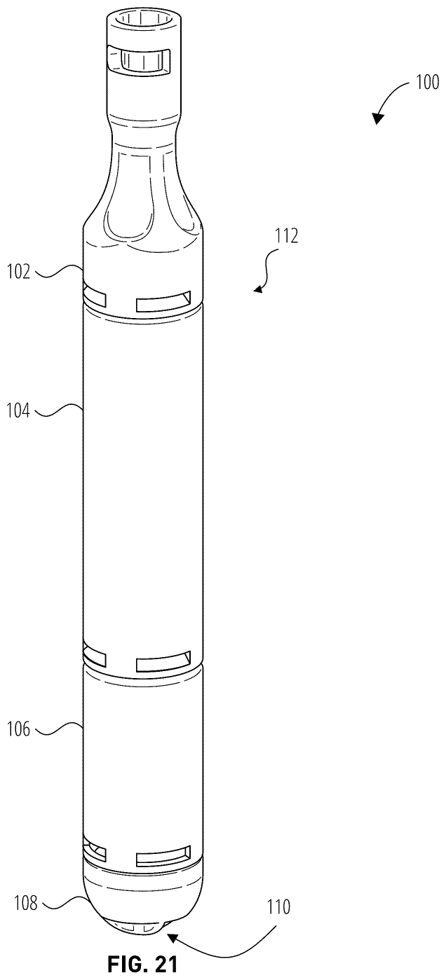

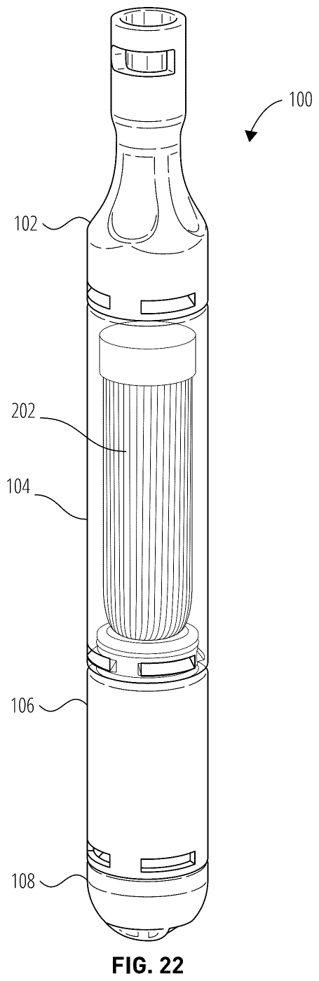

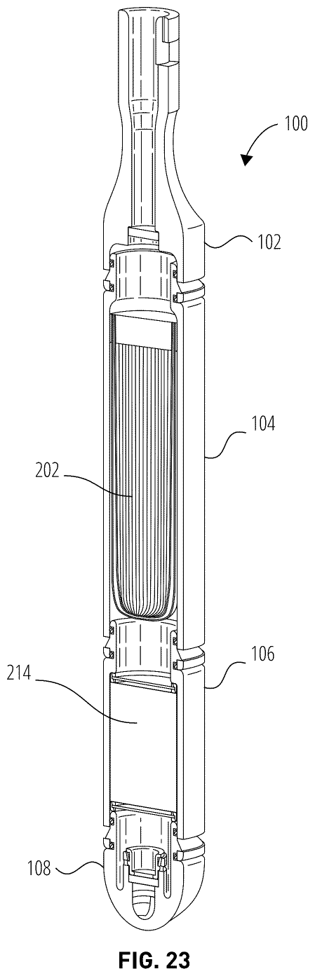

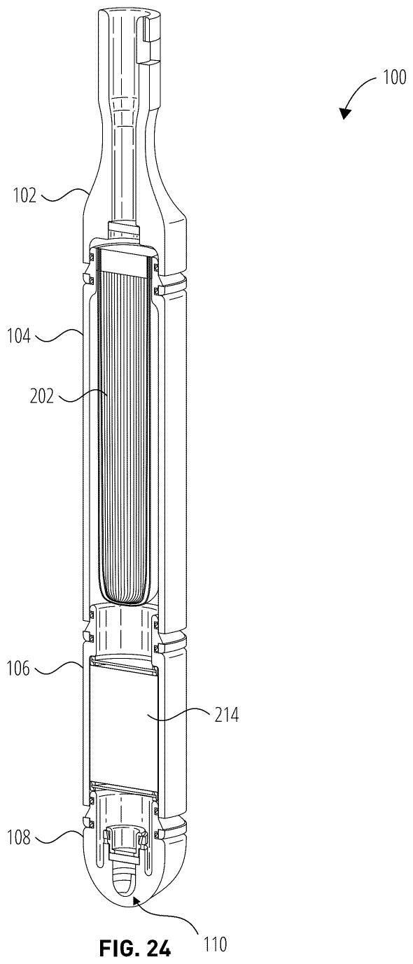

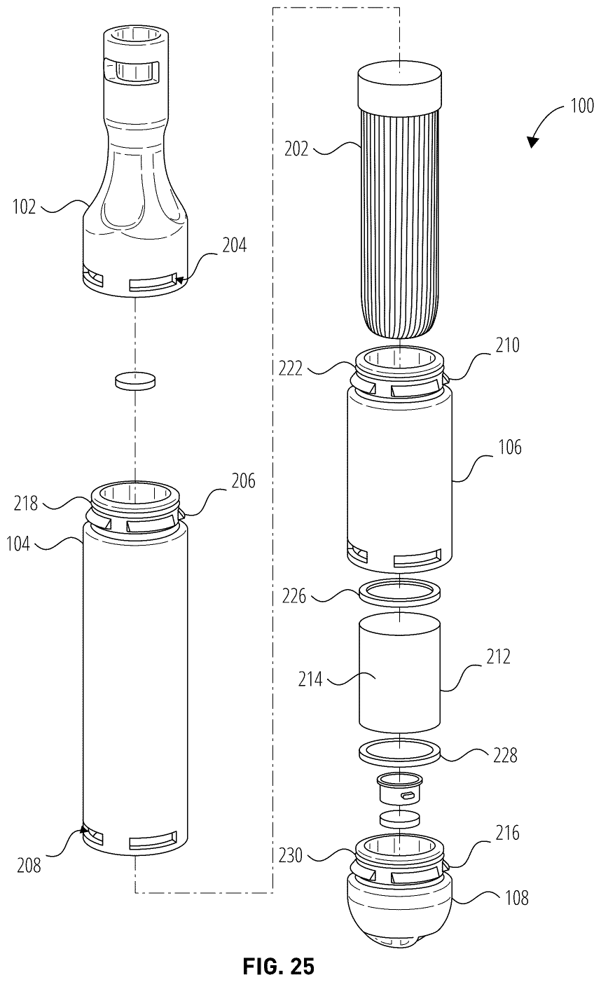

FIG. 21-FIG. 25 is a 3D rending of an example of the system 100. The example in FIG. 14 depicts the housing 112, which includes the neck portion 102, the upper portion 104, the lower portion 106, and the end cap 108, which defines the inlet 110. FIG. 22 is a partially transparent view of the example in FIG. 21. The upper portion 104 houses the microbial filter 202. FIG. 23 is a cross section of the example in FIG. 21. The upper portion 104 houses the microbial filter 202. The lower portion 106 houses the disinfecting agent 214. The end cap 108 defines the inlet 110. FIG. 24 is a 3D rendering of a partially transparent isometric view of the example system 100 in FIG. 23. FIG. 24 demonstrates that the housing 212 does not prevent fluid flow into the inlet 110. FIG. 25 is a partially exploded view of the example in FIG. 21.

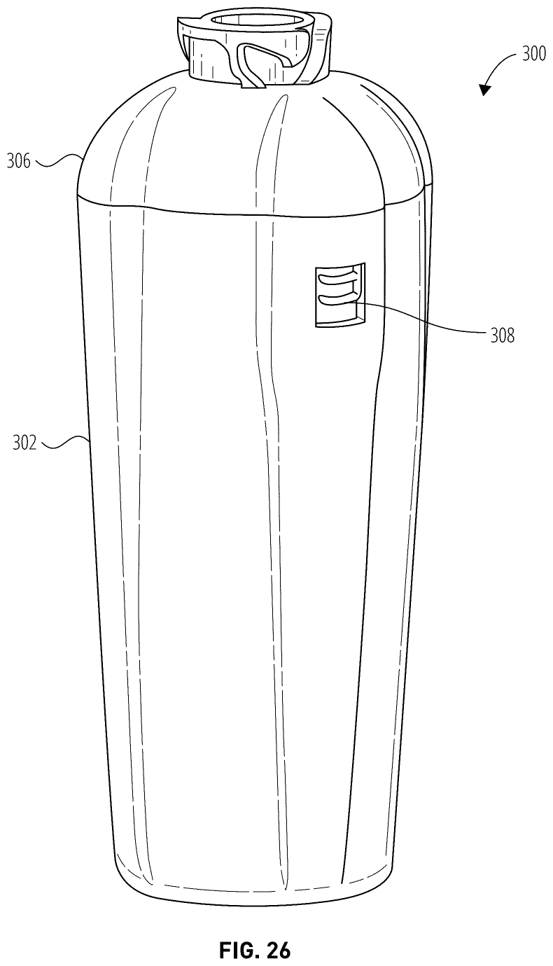

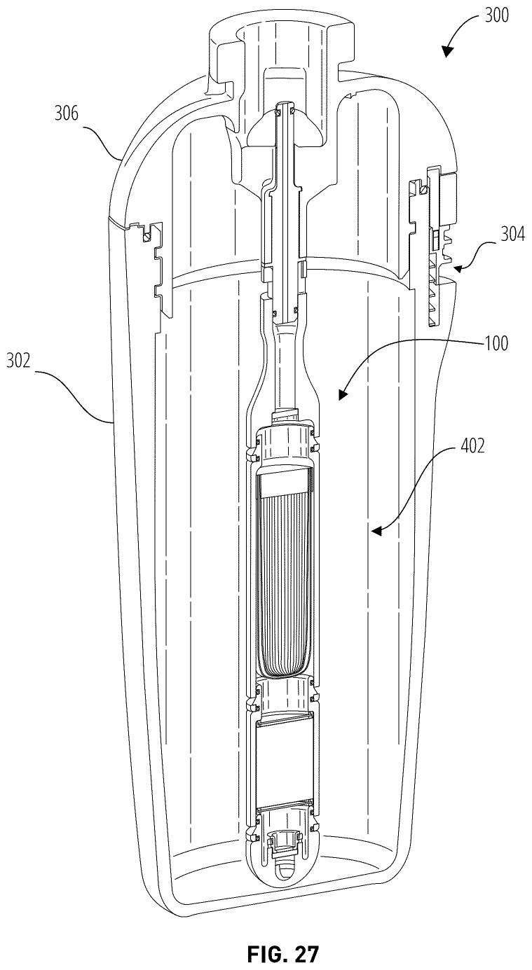

FIG. 26 and FIG. 27 is an isometric 3D rendering of an example of the system 300. The system 300 houses the system 100. The system 100 couples to the lid portion 306. FIG. 27 is a section view of the example in FIG. 26 along line 4-4 of FIG. 4.

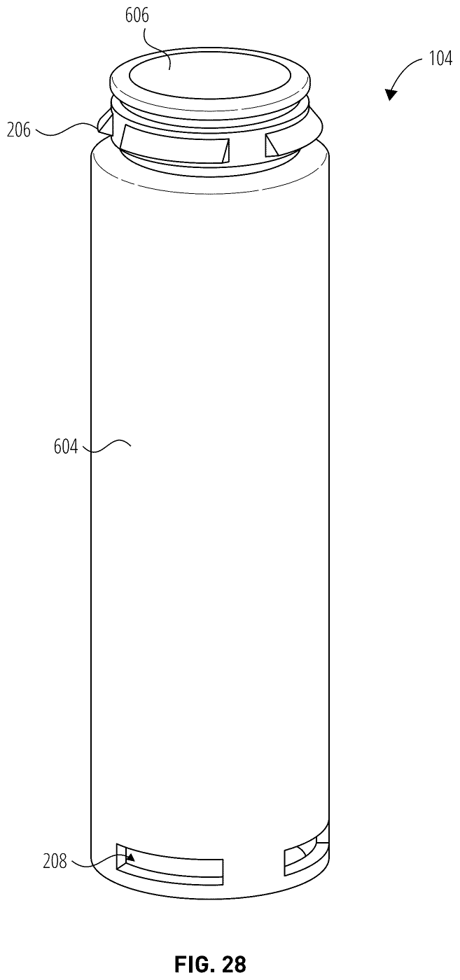

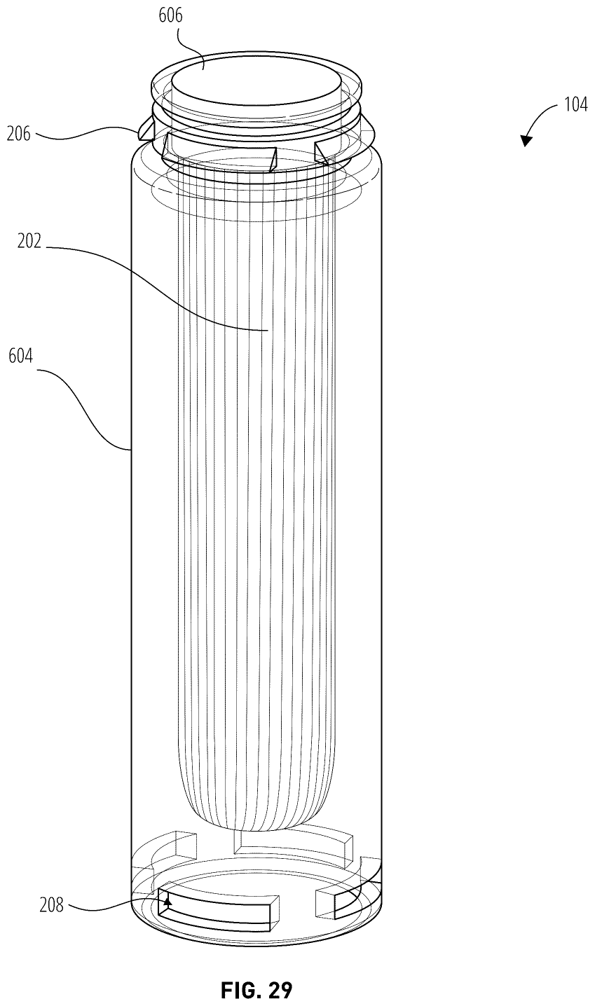

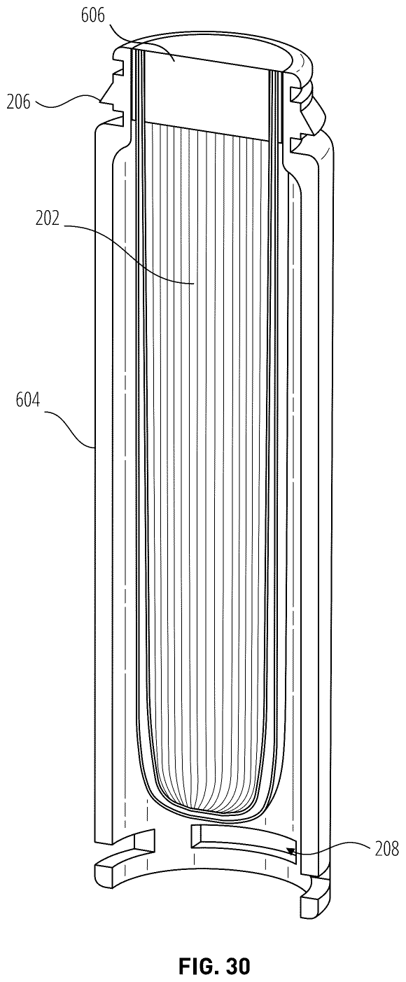

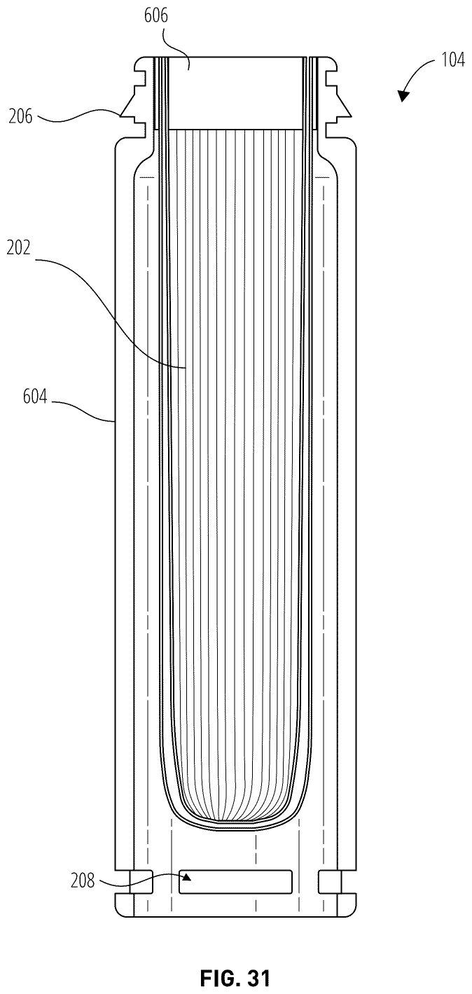

FIG. 28-FIG. 31 depict an example of the upper portion 104. FIG. 28 is a 3D rendering of an example of the upper portion 104. FIG. 29 is a partially transparent view of the example in FIG. 28. FIG. 30 is an isometric section view of the example in FIG. 28 along section line 2-2 of FIG. 2. FIG. 31 is a front section view of the example in FIG. 28.

What is claimed is:

1. A system for removing a microbe from a liquid comprising:
a housing;
a microbial filter disposed within the housing;
a disinfecting agent disposed in the housing, wherein a flow of the liquid passes through the microbial filter and the disinfecting agent thereby trapping and/or killing the microbe, generating a cleaned liquid.

2. The system of claim 1, wherein the microbe comprises a non-tuberculosis mycobacterium.

3. The system of claim 1, wherein the liquid comprises one or more of a dental water supply or source water.

4. The system of claim 1, wherein the disinfecting agent comprises at least one of: iodine, silver, copper, titanium, chlorine dioxide, chlorhexidine gluconate, hydrogen peroxide, cetylpyridinium chloride, or combinations thereof.

5. The system of claim 1, further comprising an enclosure configured to receive the housing.

6. The system of claim 1, further comprising a collar, the collar including:
a lumen formed therein and configured to receive a hook-shaped adaptor, the hook-shaped adaptor fluidly coupled to a conduit, and
a flow path formed within the collar, wherein:
a first end of the flow path is couplable to a neck portion of the housing and receives the cleaned liquid,
the cleaned fluid passes from the first end of the flow path, through the flow path to a second end of the flow path,
the hook-shaped adaptor is received in, and fluidly coupled to, the second end of the flow path, and
the conduit receives the cleaned fluid via the hook-shaped adaptor.

7. The system of claim 1, wherein the microbial filter comprises a hollow fiber filter.

8. The system of claim 6, wherein the liquid flows into a lumen in the hollow fiber and subsequently through a wall of the hollow fiber.

9. The system of claim 6, wherein the liquid flows through a wall of the hollow fiber and subsequently into a lumen of the hollow fiber.

10. The system of claim 1, wherein the liquid encounters the microbial filter and subsequently encounters the disinfecting agent.

11. The system of claim 1, wherein the liquid encounters the disinfecting agent and subsequently encounters the microbial filter.

12. The system of claim 1, wherein the disinfecting agent provides a residual action downstream of the system.

13. The system of claim 1, wherein the housing includes:
a neck portion defining a first plurality of apertures;
an upper portion defining a first plurality of tangs and a second plurality of apertures;
a lower portion defining a second plurality of tangs and a third plurality of apertures; and
an end cap defining a third plurality of tangs, wherein:
the first plurality of tangs, the second plurality of tangs, and the third plurality of tangs are receivable in the first plurality of apertures, the second plurality of apertures, and the third plurality of apertures respectively to couple the neck portion to the upper portion, the upper portion to the lower portion, and the lower portion to the end cap respectively.

14. A method to treat a fluid for dental use, the method comprising:
receiving the fluid in a housing;
filtering the fluid with a filter disposed in the housing; and
disinfecting the fluid with a disinfectant disposed in the housing.

15. The method of claim 14, wherein the filter comprises a hollow fiber filter.

16. The method of claim 15, wherein a pore size of the hollow fiber filter is less than or equal to 0.2 microns.

17. The method of claim 14, wherein the disinfectant is at least one of: iodine, silver, copper, titanium, chlorine dioxide, chlorhexidine gluconate, hydrogen peroxide, cetylpyridinium chloride, or combinations thereof.

18. The method of claim 14, wherein the fluid is disinfected subsequent to filtering.

19. The method of claim 14, wherein the fluid is filtered subsequent to disinfecting.

20. The method of claim 14, further comprising accumulating the fluid in a vessel subsequent to filtering and disinfecting.
